(19) United States
(12) Patent Application Publication
(10) Pub. No.: US 2010/0124983 A1
(43) Pub. Date: May 20, 2010

(54) Gaming Machine with Secondary Interface Board for Leveraging Slot Machine Interface Board Communications

(75) Inventors: Scott T. Gowin, Reno, NV (US); Steven G. LeMay, Reno, NV (US); Scott A. Boyd, Las Vegas, NV (US); Ali M. Saffari, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 12/271,866

(22) Filed: Nov. 15, 2008

(51) Int. Cl. G06F 17/00

(52) U.S. Cl. 463/25; 463/40

(57) ABSTRACT

Methods and apparatus for providing customized content on a gaming machine configured to generate wager-based games are described. In particular, methods and apparatus are described in which a secondary interface board, coupled to a master gaming controller and one or more communication paths associated with a slot machine interface board, performs various functions. The secondary interface board may be used to extract event information from the one or more communication paths that are used. The event information may be used to effect an operation on the gaming machine. Further, in various embodiments, the SIB may emulate device communications on the one or more communications paths, control devices and communicate with remote devices.

### COPYRIGHT NOTICE

A portion of the invention of this patent document contains or may contain material which is subject to copyright protection. The copyright owner has no objection to the photocopy reproduction by anyone of the patent document or the patent invention in exactly the form it appears in the Patent and Trademark Office patent file or records, but otherwise reserves all copyright rights whatsoever.

### TECHNICAL FIELD

The present invention relates generally to gaming devices and systems, and more specifically to providing player tracking services on a gaming machine.

### BACKGROUND

Casinos and other forms of gaming comprise a growing multi-billion dollar industry both domestically and abroad, with electronic and microprocessor based gaming machines being more popular than ever. A gaming entity that provides gaming services may control gaming devices that are globally distributed in many different types of establishments. For example, gaming machines may be placed in casinos, convenience stores, racetracks, supermarkets, bars and boats. Further, via a remote server, a gaming entity may provide gaming services in locale of a user's choosing, such as on a home computer or on a mobile device carried by the user.

Electronic and microprocessor based gaming machines can include various hardware and software components to provide a wide variety of game types and game playing capabilities, with such hardware and software components being generally well known in the art. For example, bill validators, coin acceptors, card readers, keypads, buttons, levers, touch screens, displays, coin hoppers, player tracking units and the like are examples of hardware that can be coupled to a gaming machine. Software components can include, for example, boot and initialization routines, various game play programs and subroutines, credit and payout routines, image and audio generation programs, security monitoring programs, authentication programs and a random number generator, among others.

The functions available on a gaming machine may depend on whether the gaming machine is linked to other gaming devices. For instance, when connected to other remote gaming devices, a gaming machine may provide progressive jackpots, player tracking and loyalty points programs, cashless gaming, and bonusing among other items. Many of these added components, features and programs can involve the implementation of various back-end and/or networked systems, including more hardware and software elements, as is generally known.

In a typical casino-based electronic gaming machine, such as a slot machine, video poker machine, video keno machine or the like, a game play is initiated through a wager of money or credit, whereupon the gaming machine determines a game outcome, presents the game outcome to the player and then potentially dispenses an award of some type, including a monetary award, depending upon the game outcome. In this instance, the gaming machine is operable to receive, store and dispense indicia of credit or cash as well as calculate a gaming outcome that could result in a large monetary award. The gaming machine is enabled to operate in this manner because it is placed typically in a location that is monitored (e.g., a casino), the gaming machine hardware and software components are secured within a locked cabinet and the gaming machine includes a security system for detecting fraud or theft attempts.

Because gaming machines can be operable to accept, store, dispense and/or award large sums of money, gaming machines are often the targets of theft attempts. Thus, besides including a security system, gaming software and gaming hardware are designed and/or selected to resist theft attempts and include many security features not present in personal computers or other gaming platforms. For example, a hardware-based security method for preventing illegal software modification is to store gaming software on an unalterable memory, such as an on EPROM, a read-only CD/DVD optical disc or a read-only disk memory with write capability disabled. As another example, a software-based security method for preventing/detecting illegal software modifications is to execute authentication routines that compare information stored and programs executed on the gaming machine against known and trusted information. The trusted information and authentication routines can be stored in a trusted memory location such as a verified EPROM on the gaming machine.

One advantage of utilizing the hardware and software based security methods described above is that the potential for fraud and theft is greatly reduced. Further, for gaming software approved by a gaming regulator to ensure fairness, another advantage is that the hardware and software based security methods can be used to detect any subsequent modifications to the gaming software that might put a player at an unfair disadvantage. One disadvantage of the security methods described above is that the ability to later alter or expand gaming software to add additional features or correct errors is somewhat limited. For instance, for gaming machines that utilize EPROM's to store executable gaming software, the EPROM has to be physically replaced in the gaming machine to alter the gaming software.

A gaming entity may provide gaming services to tens of thousands of users. For instance, a single land-based casino may include thousands of gaming machines. Player's gaming interests are constantly changing and the effort associated with providing fresh content to users is quite costly. The ability of a casino operator to maximize their operating profits and keep their customers happy is directly linked to their ability to provide new and desirable gaming content. In view of the above, it would be desirable to provide gaming apparatus and method that reduce the costs associated with providing new gaming content and player tracking content on gaming devices.

### SUMMARY

The present invention addresses the need described above by providing a gaming system. The gaming system may comprise a number of host devices each coupled to one or more gaming machines. The gaming machines may be operable to provide wagering on an outcome of a game of chance, display the outcome of the game of chance, accept cash or an indicia of credit and dispense an award, such as cash or indicia of credit, to a player utilizing the gaming machine.

One aspect of present invention relates to a gaming machine comprising: 1) a master gaming controller, comprising a first processor and a first memory, designed or configured to control a wager-based game played on the gaming machine, communicatively coupled to a first interface board via a first communication path and a second interface board via a second communication path; 2) a display coupled to the master gaming controller designed or configured to output an outcome to the wager-based game; 3) the first interface board, comprising a second processor and a second memory, designed or configured to a) receive metering data from the master gaming controller via the first communication path, b) send metering data to a first remote server via a third communication path, c) send and receive player tracking information to the first remote server via the third communication path and d) control at least one peripheral device including communicating with the at least one peripheral device via a fourth communication path including an end point on the first interface board; 4) the second interface board, comprising a third processor and a third memory, designed or configured to a) receive, via a fifth communication path, data associated with the fourth communication path; b) interpret the data received via the fifth communication path; c) in response to interpreting the data, determine whether an event has occurred, d) generate a message including information related to the event and e) send the message to the master gaming controller via the second communication path; wherein in response to receiving the message an operation is effected on the gaming machine by the master gaming controller; and 5) an input device coupled to the master gaming controller for receiving cash or an indicia of credit.

In particular embodiments, the first interface board and the at least one peripheral device may be components of a player tracking unit coupled to the gaming machine. The at least one peripheral device may be one of a card reader, a display or a mechanical key pad. The first interface board may be further designed or configured to control a plurality of peripheral devices where the plurality of peripheral devices includes a card, a display and a mechanical key pad.

In other embodiments, the data received via the fifth communication path may include data associated with a player tracking system. The at least one peripheral device is a card reader and the data received via the fifth communication path may include card data read from a card inserted in the card reader. The display may be a video display and wherein response to receiving the message from the second interface board, the operation effected by the master gaming controller is to output video content on at least a portion of the video display. The video content that is output may be an enhancement to a player tracking function associated with the first interface board. Further, the video content may be generated from a media application downloaded from a second remote server communicatively coupled to the master gaming controller.

In yet other embodiments, the gaming machine further comprises the at least one peripheral device and the second interface board is further designed or configured to send a command, instructions or data to the at least one peripheral device via the fifth communication path. In particular, the second interface board may be designed or configured to control the at least one peripheral input device. The second interface board may be further designed or configured to receive a first communication for the at least one peripheral device, to emulate the at least one peripheral device to generate a response to the first communication that the first interface board is programmed to receive from the at least one peripheral device and send the response to the first interface board via the fifth communication path. The at least one peripheral device may be a card reader, a display or a mechanical key pad.

In other embodiments, the second interface board may be further designed or configured to communicate with a second remote server. In addition, a card reader may be coupled to the second interface board. The second interface board may be further designed or configured to control the card reader and send information read from a card inserted into the card reader to the master gaming controller. Also, the second interface board may be further designed or configured to receive a first communication sent from the first communication board to the card reader and forward the first communication to the card reader.

In one instance, the at least one peripheral device that the first interface board is designed or configured to control may be a first display device. The second interface board may be further designed or configured to i) receive a first communication sent from the first interface board to the first display device where the first communication includes information to display on the first display device, ii) emulate the first display device to generate a response to the first communication that the first interface board is programmed to receive from the first display device and iii) generate a second communication that enables the information included in the first communication to be displayed on a second display device. The second display device is the display coupled to the master gaming controller. In another instance, the at least one peripheral device that the first interface board is designed or configured to control may be a mechanical key pad. The second interface board may be further designed or configured to i) receive data input via a touch screen display, ii) convert the data input via the touch screen display to a format that the first interface board is programmed to receive from the mechanical key pad and iii) send a first communication to the first interface board including the converted data.

The second interface board may be further designed or configured to receive information sent from the first interface board to the first remote server via the third communication path or sent from the first remote server to the first interface board via the third communication path. The second interface board may be further designed or configured to emulate the player tracking host to generate a first communication to effect an first operation on the first interface board. The operation may be related to a transfer of credits on the gaming machine or the operation may be related to a bonus condition on the gaming machine.

Another aspect of the present invention may be related to a gaming machine comprising: 1) a master gaming controller, comprising a first processor and a first memory, designed or configured to control a wager-based game played on the gaming machine, communicatively coupled to a first interface board via a first communication path and a second interface board via a second communication path; 2) a display coupled to the master gaming controller designed or configured to output an outcome to the wager-based game; 3) the first interface board, comprising a second processor and a second memory, designed or configured to a) receive metering data from the master gaming controller via the first communication path, b) send metering data to a first remote server via a third communication path, c) send and receive player tracking information to the first remote server via the third communication path, d) control a card reader, a first display and a mechanical key pad; and e) communicate with the card reader, the first display and the mechanical key pad via one or more communication paths with end points on the first interface board; 4) the second interface board, comprising a third processor and a third memory, designed or configured to a) to receive communications from the first interface board to the card reader, the first display or the mechanical key pad sent via the one or more communication paths with the end points on the first interface board; b) interpret the communications; c) emulate the mechanical key pad and the first display to generate responses that the first interface board is programmed to receive from the mechanical key pad or the first display device; d) send the generated responses to the first interface board; and e) communication with the master gaming controller; and 5) an input device coupled to the master gaming controller for receiving cash or an indicia of credit. The master gaming controller may be further designed or configured to receive information sent from the first interface board to the first display device via the one or more communication paths with endpoints on the first interface board from the second interface board via the second communication path and output the information on the display.

In particular embodiments, the gaming machine may be operable to establish a communication link with a host device that enables content provided by the host device to be output on the gaming machine. To output the content provided by the remote host, a host-controlled process that may be authenticated by the gaming machine and executed in a secure memory location such that it may be isolated from other processes executing on the gaming machine may be utilized. The host-controlled processes may be decoupled from the process used to execute the game of chance played on the gaming machine such that the content output by the host-controlled process doesn't alter the play of game of chance.

In addition, the gaming machine may monitor the resources utilized by the host-controlled process to prevent the game play from being less than optimal. For instance, a host-controlled process could overburden the CPU on the gaming machine resulting in less than optimal graphical output for the game of chance or host-process could produce audio output that clashed with the audio output related to the play of the game of chance to produce an unpleasant gaming experience. In each of these instances, to prevent the game play experience on the gaming machine from degrading, the gaming machine may limit and/or prevent access to certain resources (e.g., CPU usage may be limited) and actively monitor resources utilized by the host-controlled process to insure that adequate game play performance is maintained.

Another aspect of the invention pertains to computer program products including a machine-readable medium on which are stored program instructions for implementing any of the methods described above. Any of the methods of this invention may be represented as program instructions and/or data structures, databases, etc. that can be provided on such computer readable media.

In certain embodiments the devices and methods described herein include, but are not limited to any combination of two or more, three or more, or four or more, of the elements or features described above and/or any combination of two or more, or three or more, or four or more of the elements or features described herein.

Aspects of the invention may be implemented by networked gaming machines, game servers and other such devices. These and other features and benefits of aspects of the invention will be described in more detail below with reference to the associated drawings. In addition, other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and process steps for the disclosed inventive systems and methods for providing a customizable interface and remote management of content on a gaming machine. These drawings in no way limit any changes in form and detail that may be made to the invention by one skilled in the art without departing from the spirit and scope of the present invention.

FIG. 1 is block diagram of an embodiment of a gaming system including a secondary interface board coupled to a master gaming controller and a communication path associated with a slot machine interface board.

FIG. 2 is block diagram of an embodiment of a gaming system including a secondary interface board coupled to a master gaming controller and a communication path associated with a slot machine interface board where the secondary interface board provides device emulation.

FIG. 3 is block diagram of an embodiment of a gaming system including a secondary interface board coupled to a master gaming controller and a communication path associated with a slot machine interface board where the secondary interface board provides device emulation and control.

FIG. 4 is block diagram of an embodiment of a gaming system including a secondary interface board coupled to a server and a first, second and third communication paths associated with a slot machine interface board.

FIG. 5 is flow diagram of method of providing communication in a gaming machine using a secondary interface board coupled to a master gaming controller and a slot machine interface board.

FIGS. 6A, 6B, and 6C are block diagrams illustrating an interaction between a host and gaming machine for one embodiment of the present invention.

FIG. 7A is a block diagram illustrating an interaction between two hosts and a gaming machine for one embodiment of the present invention.

FIG. 7B is a block diagram of hardware and software components and their interactions on a gaming machine for embodiments of the present invention.

FIG. 8 illustrates a perspective view of one embodiment of a gaming machine.

FIG. 9 illustrates a block diagram of a gaming system for embodiments of the present invention.

### DETAILED DESCRIPTION

Exemplary applications of systems and methods according to the present invention are described in this section. These examples are being provided solely to add context and aid in the understanding of the present invention. It will thus be apparent to one skilled in the art that the invention may be practiced without some or all of these specific details. In other instances, well known process steps have not been described in detail in order to avoid unnecessarily obscuring the present invention. Other applications are possible, such that the following example should not be taken as definitive or limiting either in scope or setting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

Although the present invention is directed primarily to gaming machines and systems, it is worth noting that some of the apparatuses, systems and methods disclosed herein might be adaptable for use in other types of devices, systems or environments, as applicable, such that their use is not restricted exclusively to gaming machines and contexts. Such other adaptations may become readily apparent upon review of the inventive apparatuses, systems and methods illustrated and discussed herein.

In the following figures, method and apparatus applicable to various gaming system configurations and their associated components are described. The gaming systems may comprise a network infrastructure for enabling one or more hosts to communicate with gaming machines. The gaming machines may be operable to provide wagering on a game of chance. A plurality of peripheral gaming devices, such as bill/ticket validators, printers, mechanical displays, video displays, coin hoppers, light panels, input buttons, touch screens, key pads, card readers, audio output devices, etc., may be coupled to the gaming machine. The gaming devices may be controlled by a master gaming controller executing authenticated software to provide a gaming interface for a game play experience on the gaming machine.

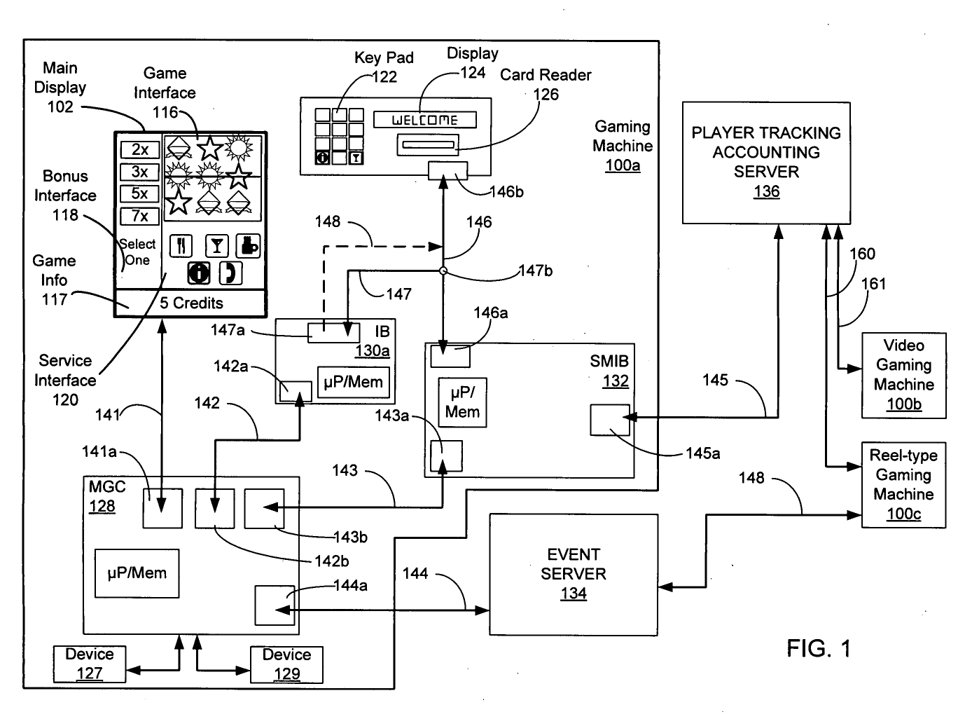

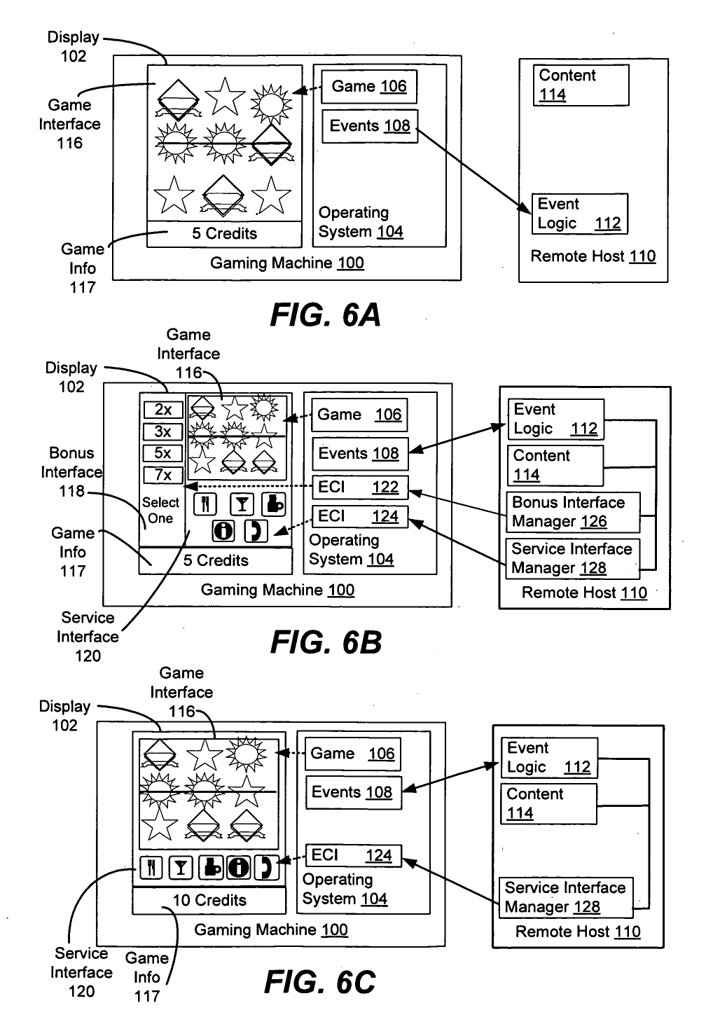

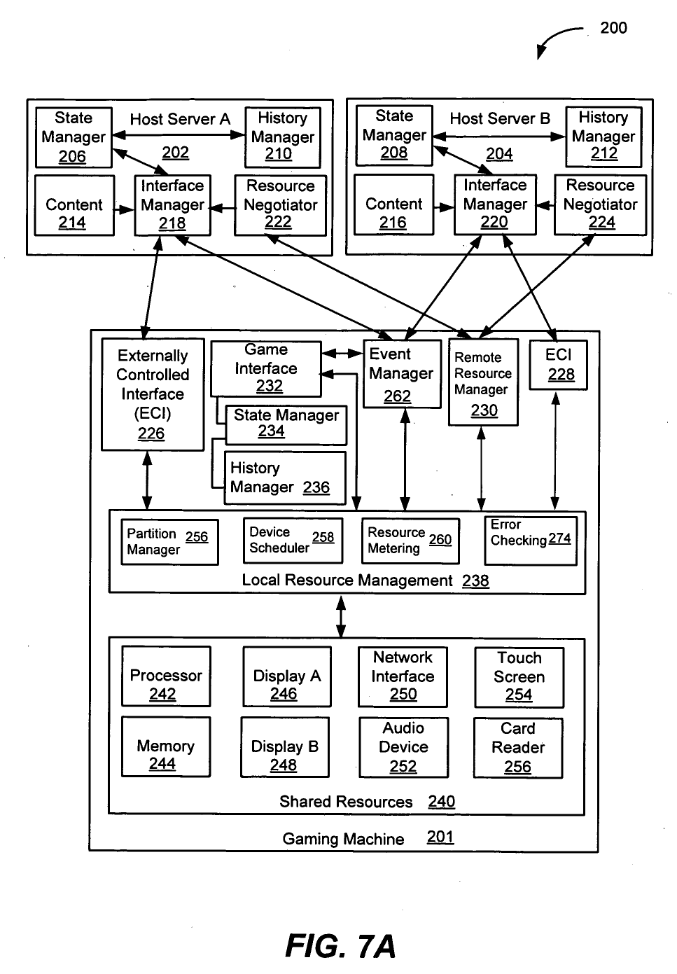

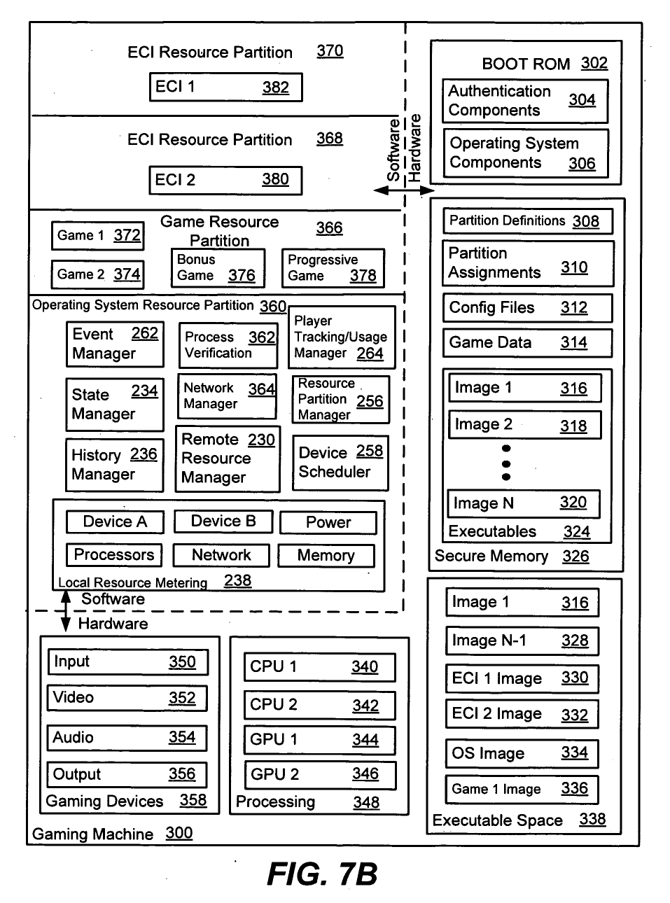

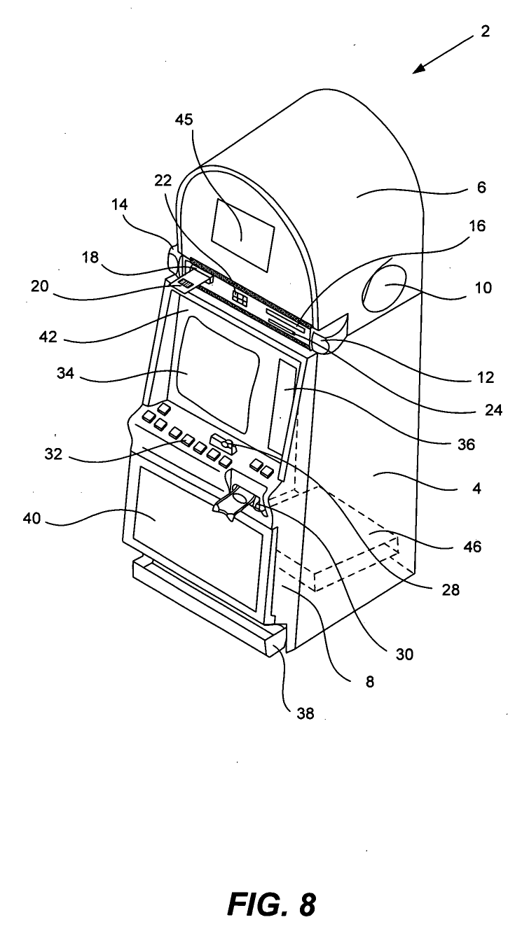

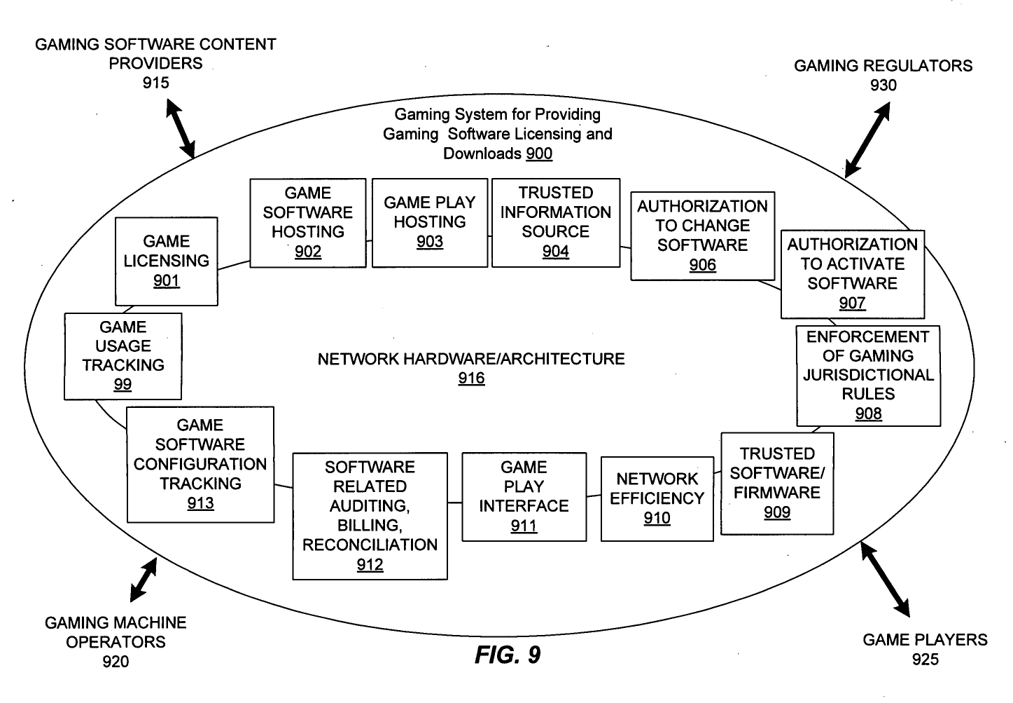

Aspects of the present invention describe method and apparatus for providing customized content on a gaming machine configured to generate wager-based games. In particular, in regards to FIGS. 1-5 apparatus and methods are described in which a secondary interface board (SIB) is coupled to a master gaming controller (MGC) and one or more communication paths associated with a slot machine interface board (SMIB). The SIB may be used to extract event information from the one or more communication paths. The event information may be used to effect an operation on the gaming machine. Further, in various embodiments, the SIB may emulate device communications on the one or more communications paths, control devices directly, act as conduit for device control by other devices and/or communicate with remote devices. In FIGS. 6A-6C, embodiments of interactions between a host and a gaming machine utilizing an externally-controlled interface processes are described. In particular embodiments, custom content may be provided on a display device, such as a main display or secondary display on a gaming machine, in conjunction with commands, instructions and/or data from a remote host, a MGC, a SMIB, a SIB alone or in combination. In FIG. 7A-7B, embodiments of method and apparatus related to resource and event monitoring on a gaming machine are described. In particular embodiments, the resource monitoring may be applied to the MGC to ensure game output is always maintained. Finally, in FIGS. 8 and 9, details of a wager-based gaming machine and an associated gaming system for embodiments of the present invention are described.

### Gaming System and Gaming Machine Components

FIG. 1 is block diagram of an embodiment of a gaming system including a secondary interface board (SIB) coupled to a master gaming controller (MGC) and a communication path associated with a slot machine interface board (SMIB). First, the gaming system components are described and then, embodiments of the SIB utilized in conjunction with these components are described for the purposes of illustration. The gaming system comprises a plurality of gaming machines, such as 100a, 100b and 100c. Each gaming machine may communicate with a remote server 136 via communications paths, such as 145, 160 and 161. The communications paths, 145, 160 and 161 may comprise one or more wireless or wired communication links, which may vary depending on an instantiation of a local network topology.

The remote host 136 may provide one or more services to the gaming machines, such as but not limited to bonusing on the gaming machine, player tracking accounts, accounting/monitoring of gaming machine activity, such as money-in/money-out and cashless services, such as downloading of credits to the gaming machine or transferring credits from the gaming machine to a remote account. Further details of such services that are applicable to the embodiments of instant application are described in U.S. Pat. No. 5,429,361 by Raven, et al., titled, “Gaming Machine information, communication and display system,” U.S. Pat. No. 5,655,961, by Acres et al, titled, “Method of Operating Networked Gaming Devices,” and U.S. Pat. No. 7,112,138, by Nguyen, et al., titled, “Player Tracking Communication Mechanisms in a Gaming Machine,” each of which is incorporated by reference and for all purposes.

The remote host 136 may communicate with a Slot Machine Interface Board (SMIB) coupled to each gaming machine. The gaming machines are not limited to slot machines with mechanical display devices and may be any type of gaming machine that provides services related to wager-based gaming, such as video slot machines, video poker, bingo, etc. A defined communication protocol that describes information that is to be communicated including its format may be utilized between the gaming machines, such as 100a, 100b and 100c, and the remote host via the SMIB. Examples of these protocols include but are not limited to a Slot Accounting System (SAS) protocol and SuperSAS protocol by IGT (Reno, Nev.) and SDS protocol by Bally Technologies (Las Vegas, Nev.). Another example is the G2S protocol adopted by the Gaming Standards Association (Hayward, Calif.).

The remote host 136 may communicate with a gaming machine via a slot machine interface board coupled to the gaming machine. For example, the SMIB 132 may comprise a microprocessor and memory, an interface 145a for communicating with the remote host 136 via the communication path 145, a microprocessor and memory, an interface 143a for communicating with the MGC 128 on the gaming machine via communication path 143 and one or more interfaces, such as 146a, for communicating with one or more peripheral devices, such as but not limited to the card reader 126, the display 124 and the mechanical key pad 122.

In one embodiment, the communication path 146 may comprise a bundle of connections between each of the devices, such 122, 124 and 126, such as a separate communication connection for each of the devices. Thus, 146b may comprise a plurality of device interfaces. In other embodiments, embodiments, the devices may communicate via a common communication connection and protocol, such as via USB or FireWire.™ In these embodiments, interface 146b might be a common USB hub where each of the key pad 122, 124 and 126 are coupled to the USB hub.

In some embodiments, the SMIB 132 may comprise multiple boards, such as a first board comprising a processor and memory for performing accounting functions, metering functions and associated communications and a second board comprising a processor and memory for performing player tracking functions and controlling peripheral devices, such as the key pad 122, display 124 and card reader 126. There may be various communication links between the boards. Acres '961 and Raven '361, previously incorporated herein described such embodiments. In other embodiments, a single board design may be utilized.

The SMIB 132 may communicate with the MGC 128 via communication path 143. Thus, the SMIB 132 may comprise an interface 143a for communicating with the MGC 128 and the MGC 128 may comprise an interface 143b for communicating with the SMIB 132. In some embodiments, to prevent static discharge from reaching the MGC from the one or more peripheral devices coupled to the SMIB 132, some form of electrical isolation may be utilized. For instance, interface 143b may include an opticoupler design that converts electrical signals to light signals. Details of this type of design are described in U.S. Pat. No. 7,047,338, by Nguyen, et al., titled, “Configurable Hot-Swap Communication,” which is incorporated by reference and for all purposes and Acres '961 previously incorporated herein.

Typically, the commands, instructions and/or that are allowed to be transferred between the SMIB 132 and the MGC 128 via communication path 143 are limited and well defined according to an implemented communication protocol. For example, the MGC 128 may send metering data to SMIB 132 and the SMIB may send commands, such as bonusing commands or instructions and associated data for depositing credits from a remote account to the gaming machine 100a. However, the MGC 128 doesn't send or receive information via communication path 143 to enable it to control devices, such 122, 124 and 126. Information regarding the status of devices 122, 124 and 126 or information/data generated by these devices also is not passed via communication path 143. In traditional designs, the SMIB 132 is not programmed to process or act upon commands, data or instructions related to the control of these devices from the MGC nor is the MGC programmed to control these devices.

Examples of information, data or commands that may be sent by communication path 143 include but are not limited to 1) machine information, such as serial number, 2) jackpot notification, 3) money-in (also, called coin-in), 4) money out (also called coin-out), 5) jackpot information (e.g., jackpot awarded and possible hand pay), 6) credit information, such as credits to be transferred to or from the gaming machine, 7) paytable information, 8) bonusing information, 9) reconfiguration commands, 10) door, cabinet or machine status information (e.g., open door, power, or tilt condition) and 11) game initiation and wager amounts. A communication protocol is used to define the information and its associated format that is allowed to be passed between the MGC 128 and SMIB 132. For example, the SAS, superSAS, SDS, G2S protocols referred above may define the information type and format that are allowed.

One purpose of the communication paths, such as 143 and 145, and associated protocols between a gaming machine and a remote host is to obtain metering data which is important for the both casino operations and regulatory purposes. For example, the metering data provides information that allows the performance of a casino to be evaluated and income that is generated by each gaming machine to be reported to a regulatory agency. Player tracking systems and other applications have evolved to leverage these communication paths. In many instances, casinos have developed a large infrastructure, including both hardware and software, for processing data obtained via these communication paths.

In SMIB 132, the microprocessor and memory may be utilized to operate the key pad 122, display 124 and card reader 126 as a player tracking device and/or cashless device. The key pad 122 may be a mechanical input device and may include buttons for requesting a service or information. The key pad 122 may be used to enter numbers, such as an account number, a PIN or an amount of credit to transfer to or from the gaming machine. In older devices, the display 124 may be a vacuum fluorescent display, such as 12 or 16 digit VFD. The card reader 126 may be operable to read a magnetic striped card or smart card. The card reader 126 may include a number of sensors to detect whether a card is inserted in the card reader slot as well as inserted correctly. An indicator such as a lighted bezel around the card reader slot may be used to indicate whether a card is inserted correctly or incorrectly. Other devices that may also be coupled to the SMIB 132 via communication path 146 and peripheral devices 122, 124 and 126 are provided for illustrative purposes only.

The SMIB 132 may be designed or configured to interpret raw data received from one or more input devices via communication path 146, such as but not limited to the activation of one or more input buttons on the key pad, card data read from card reader 126 or sensor data related to card detection from the card reader 126. The SMIB 132 may also be designed or configured to send commands, data or instructions to the input devices, such as key pad 122 and card reader 126. For example, the SMIB 132 may send command, instructions and/or data for writing information to a card inserted in the card reader or acknowledging that data has been received from the devices. Further, the SMIB 132 may also be designed or configured to send commands, data or instructions for controlling the output devices. For example, the SMIB 132 may send a message to the display 124 for output, such as a welcome message or a player name. As another example, after receiving an indication a sensor associated with a card reader 126 that a card is inserted incorrectly, the SMIB 126 may send an instruction to an indicator light, such as a lighted bezel, to activate a light of a particular color, such as red, to indicate that the card is inserted incorrectly.

The MGC 128 may control a wager-based game played on the gaming machine. The MGC 128 may comprise one or more processor and one or more memories. The outcome of the game may be generated locally, remotely (e.g., a remote server may generate an outcome and send it to the gaming machine) or combinations thereof. Further, outcome of the game may be presented locally, such as on main display 102 or presented remotely. For local presentation on a video gaming machine, such as 100a, the video portion of the game presentation may be presented on all or portion of the main display, such as in the game interface portion 116. Information about the game and machine status, such as credit information may be presented in the game information portion 117 of the display.

For a remote game presentation, a game outcome presentation may be generated on a hand-held device in conjunction with the MGC 128. In one embodiment, a game outcome presentation may be streamed to a remote device. In another embodiment, the MGC may generate commands, instructions or data for generating the game outcome presentation on a remote device. The instructions may include software instructions that are executable or are executable after one or more operations, such as after compiling the software instructions. For instance, the remote device may execute a flash application for presenting the game outcome presentation on remote device in conjunction with commands, data and/or instructions received from the MGC 128. The flash application may have been downloaded to the remote device from gaming machine 100a or from another device, such as event server 134. Details related to this embodiment are described in U.S. Pat. No. 6,846,238, by Wells, titled, “Wireless Game player,” which is incorporated herein by reference and for all purposes.

The MGC 128 may control money handling on the gaming machine 100a. The money handling may comprise communicating and/or controlling one or more devices, such 127 and 129, that allow a value to be input onto the gaming machine or output from the gaming machine. Examples of value that may be input to the gaming machine or output from the gaming machine may include, but are not limited to, an indicia of credit, cash, promotional credits that are cashable or non-cashable, loyalty points, coupons redeemable for discounts, offers or comps. Thus, not all value that is input into the gaming machine is necessarily redeemable for wagering. The value may be input or output via peripheral devices, such as but not limited, to a bill validator/ticket acceptor, coin acceptors, coin dispensers card readers, printers and/or communication interfaces to remote devices. The MGC 128 may report data and may receive data related to money handling via the communication path 143 using the interface 143b to the communication path.

### Secondary Interface Board

The secondary interface board (SIB) 130a may comprise a processor and memory, a first interface 147a for connecting to communication path 147 between the SIB 130a and communication path 146 and a second interface 142a for connecting to communication path 142 between the SIB 130a and the MGC 128. In one embodiment, the interface 142b for connecting to communication path 142 may be a USB compatible interface. The MGC 128 may be configured to treat the SIB 130a as a peripheral device like peripheral devices 127 and 129. In particular embodiments, the MGC 128 may be configured to enumerate the SIB 130a and load a driver for communicating and performing operations associated with SIB 130a.

The SIB 130a may be connected via communication path 147 to a communication path, such as 146, between the SMIB 132 and one or more peripheral devices. The interface 147a allows signals obtained from communication path 147 to be received and interpreted by the SIB 130a. Interface 147b allows communication path 147 to receive signals from communication path 146. As described above, multiple communication paths may exist between the SMIB 132 and the peripheral devices, such as one communication path between each of the SMIB 132 and the key pad 122, display 124 and the card reader 126 or multiple peripheral devices may share a communication path. When multiple communication paths are present between the SMIB 132 and one or more peripheral devices, the SIB 130a may be connected one or more of these communication paths. Thus, although not shown, additional communication paths and communication interfaces other than 147 and 147a may be utilized with SIB 130a.

The SIB 130a and the communication path 147 with its associated interface 147a and 147b may be configured to allow communications passing between at least one peripheral device, such as 122, 124, 126 or combinations thereof, and the SMIB 132 to be also received at the SIB 130a. The messages may be embodied as signals in a particular physical format that is associated with communication path 146. The interface 147b may be configured to allow communications along signal path 146 to be properly received at each end point 146a and 146b while also allowing the communications to be also received at endpoint 147a.

In one embodiment, communications may only be read from communication path 146 such that the SIB does not add communications to the communication path 146. In another embodiment, the SIB may both read and add communications to communication path 146. In one embodiment, to add communications to communication path 146, communication path 147 may be bi-directional allowing communications to be received and sent via endpoint 147a. The sent communications may be targeted at either endpoint 146a or 146b, i.e., towards one of the peripheral devices or the SMIB 132. In another embodiment, a separate communication path, such as 148 with associated endpoint interfaces (not shown) may be utilized to add communications to communication path 146.

In particular embodiments, the added communications may be limited to only one of endpoints 146a or 146b. For instance, the added communications may be directed only at endpoint 146b, which may allow only communications towards the peripheral devices but not the SMIB 132. As another example, the added communications may be directed only at endpoint 146a, which may allow only communications with the SMIB 132 but not the peripheral devices.

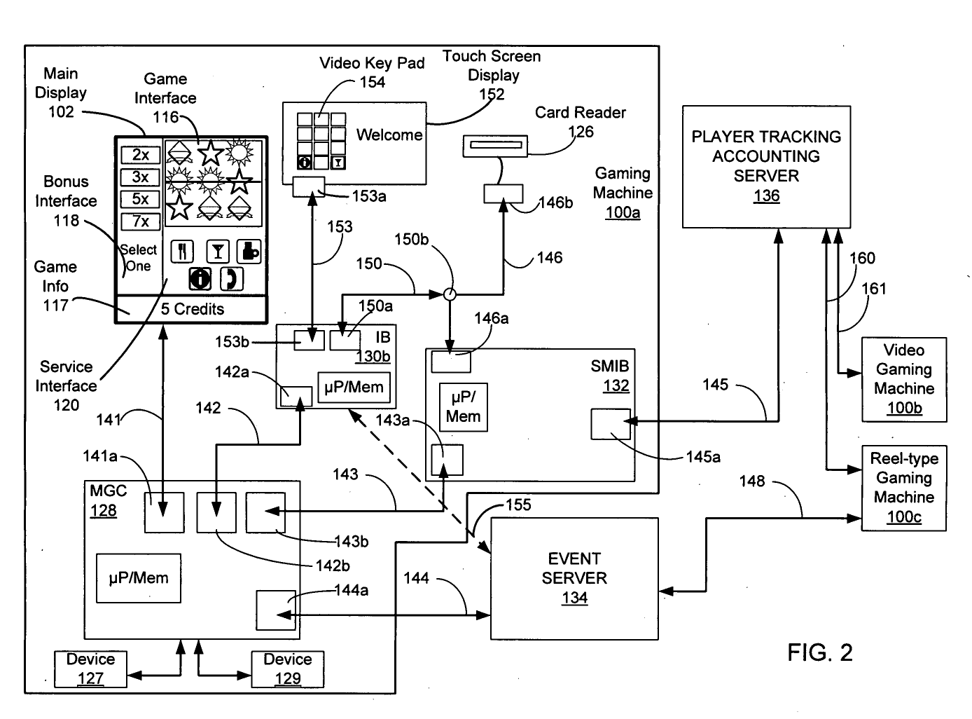

The SIB 130a may include software and/or hardware that allow communications received from communication path 146 to be correctly interpreted and information from the communications to be extracted and sent to the MGC 128 via communication path 142. For example, if the card reader 126 detects the presence of a card and sends a message to the SMIB 132 to indicate that an insertion of a card has been detected, this message may also be received by the SIB 130a and correctly interpreted. An additional message containing this information may be generated and sent to another gaming device, such as the MGC 128 or the event server 134 (see FIG. 2). This message may be sent using a different communication protocol than in which it was received. In another embodiment, the SIB 130a may receive the message from communication path 146 and encapsulate it using another protocol and then forward the message to another device where interpretation and data extraction is performed by the other device, such as the MGC 128. Thus, data extraction may be performed by the SIB 130a, by another device, each device alone or in combination with one another.

In another example, if raw data is read from the card, such as an account number and a player's name, the SIB 130a, may extract this information but may only send only a portion to another device, such as sending only the player's name to the MGC 128. In yet another example, the key pad 122 may detect an activation of a service button and information relating to the activation of the service button and send it to another device, such as the MGC 128.

In yet another example, the SMIB 132 may send commands, instructions or data for operating the peripheral devices. These commands, instructions or data may be received by the SIB 130a. For instance, the SMIB 132 may send commands, instructions or data to the display 124 to display a message including a message to display, such as “welcome player A.” This information may be extracted from the message by the SIB 130a and sent to another device, such as the MGC 128.

In another instance, the SMIB 132 may send a command to a bezel around the card reader 124 to change color to indicate a card is inserted incorrectly. In some instances, the command may only indicate that the bezel is to change color. The SIB 130a may comprise logic for command interpretation that allows an underlying meaning of the command to be interpreted and then a message associated with interpreted meaning of the command to be sent another device, such as the MGC 128. Thus, in the example above, the SIB 130a may be operable to receive the command indicating the bezel to change color, interpret that the command means a card is inserted incorrectly and send a message to another device, such as the MGC 128 indicating that a card was inserted incorrectly in the card reader 126.

The SIB 130a may be designed or configured to respond to particular communications along communication path 146 and ignore other communications. Instances of when the SIB 130a detects the presence of information may be referred to as an event and information associated with the event may be referred to as event information. Event filtering may refer to the SIB 130a ignoring some events while responding to other events. For example, the SIB 130a may be designed to only send a message to the MGC 128 to indicate that a service request button or information button has been activated on the key pad. When a numerical button is depressed, this information may not be sent to the MGC 128.

In some embodiments, the SIB 130a may be configured to receive requests from a device, such as MGC 128 or server 134, of information that it is interested in receiving from the communications on communication path 146, i.e., events that are of interest. For instance, the SIB 130a may maintain a list of events to detect and associated event information to send out where the events and associated event information that are on the event list may be modified according to commands, data or instructions received from a remote device, such as the MGC 128. Thus, items on the event list may be added or deleted over time. In some embodiments, the SIB 130a may initialize with no events on its event list and then may receive one or more items for its event list from a remote device such as the MGC 128 or event server 134.

In particular embodiments, the events that are interest may change with time depending on a context in which a peripheral device is being used. For example, the MGC 128 may not be programmed to process or utilize data associated with a numerical input of a PIN using the key pad 122 but may be programmed to process or utilize data associated with the key pad 122 when it is being used to enter an amount of credits to transfer from the MGC 128 to a remote device. The SIB 130a and/or the MGC 128 may include logic for determining a context in which one of the peripheral devices is being utilized based upon the communications between the device and the SMIB 132 and based upon the context determine whether the information is to be sent to one or more devices as event information. Thus, in general, in a first context in which a peripheral device being used, the SIB 130a may determine that the first context does not generate an event, while in a second context in which the peripheral device is being used does generate an event. Therefore, in response to determining the second context has occurred, the SIB 130a may generate an event and event information and send the event and event information to one or more devices, such as the MGC 128.

The event information generated by the SIB 130a that is extracted from communication path 146 and sent to the MGC 128 may be used to effect an operation on the gaming machine 100a. The effected operation may be generated by the MGC 128 alone or in combination with one or more remote devices, such as the event server 134. In one embodiment, the effected operation may enhance an operation of the player tracking system associated with the SMIB 132. For instance, when a service button is pressed on key pad 122, the SIB 130a may detect this event and send event information to the MGC 128 via communication path 142. In response, a window including a menu of services may be opened up on the main display 102 or another display coupled to the MGC 128. In a particular embodiment, the service interface 120 may be launched as an externally controlled interface process as is described in following sections.

The service interface window 120 may allow a player to select a service item such as a specific drink or food item from a menu that may be delivered directly to the gaming machine 100a. In some embodiments, the available food or menu items may depend on a gaming playing history that is associated with their player tracking account where different selections may be available to high value customers versus customers of a lesser value. In some embodiments, the available service items may be provided for free, at a reduced cost or at a full price. The player may be able to purchase these items that are not free using one or more of credits available on the machine and/or player tracking points that are associated with a player tracking account. Information regarding a selection of a service item may be routed to a remote device, such as the event server 134. At the event server, the service request may be processed and then, the requested service item may be delivered to the player.

In another embodiment, the SMIB 132 may be designed or configured to trigger a bonus mode on the gaming machine 100a. When a bonus event is detected by the SIB 130a and event information associated with bonus is sent to the MGC 128. An enhanced feature, such as a bonus interface 118, may be generated on display 102 of the gaming machine 100a. In yet another embodiment, when a player's name or any other information that is to be transmitted to the player via display 124 is detected by the SIB 130a and sent to the MGC 128. The presentation of this information may be also output on the gaming machine in some manner, such as by providing a window with a player tracking interface on the main display 102. Again, the response to the event may be generated by the MGC 128 alone or in combination with one or more remote devices, such as event server 134.

In yet other embodiments, the devices connected to the SMIB 132 may have no sound output capabilities or limited the sound output capabilities. The audio capabilities on the gaming machine 100a may be utilized as part of an effected operation. For instance, when a card inserted incorrectly event is generated by the SIB 130a and sent to the MGC 128, a sound may be generated on an audio device controlled by the MGC 128. The MGC 128 may also generate a video message, “such as card inserted incorrectly,” which may be output to a display device, such as display 102.

In other embodiments, when a transaction, such as transfer of credits, is generated using the SMIB 132 and the peripheral devices coupled to the SMIB 132, event information may be sent to the MGC 128 describing the transaction. In response, the MGC 128 may display a message related to the transaction and/or print a receipt associated with the transaction. The receipt may be generated automatically or in response to a prompt, such as a message “please press here to print a receipt.”

Three functions that may be implemented alone or in combination on the embodiments of SIBs described herein are peripheral device control, peripheral device emulation and communication filtering/routing in relation to the SMIB 132 and its associated peripherals. These functions are described for the purposes of illustration with respect to FIGS. 2-4, which are provided for illustrative purposes only and are not meant to be limiting. For example, peripheral device control, peripheral device emulation or communication filtering/routing may also be performed by another logic device, such as MGC 128, in conjunction with or separate from the SIB 130a. FIG. 2 is block diagram of an embodiment of a gaming system including a secondary interface board 130b coupled to a master gaming controller 128 and a communication path 146 associated with a slot machine interface board (SMB) 132 where the secondary interface board 130b provides device emulation.

In one embodiment, a touch screen display 152 is coupled to the SIB 130b via communication path 153 and communication interfaces 153a and 153b, respectively. In other embodiments, the touch screen display 152 may be directly coupled to the MGC 128 via a communication interface (not shown), such as USB interface. The touch screen display 152 may be used to replace the display 124 and key pad 122 described with respect to FIG. 1.

In this embodiment, the SMIB 132 may still be configured to communicate with a card reader 126, key pad 122 and display 124 as is shown in FIG. 1. However, the key pad 122 and display 124 have been replaced with the touch screen display 152 where the SMIB 132 is not configured to communication with the touch screen display 152. Thus, commands, instructions and/or data sent from the SMIB 132 via communication path 146 and communication interface 146a to the key pad 122 and the display 124 may not be recognized by the touch screen display 152 and commands, instructions or data sent from the touch screen display 152 via communication path 153 to the SIB 130b may not be recognized by the SMIB 132.

The SIB 130b may be configured to emulate the key pad 122 and display 124 such that it responds with communications to the SMIB 132 via communication interface 150a, communication path 150 and communication path 146 as if the devices are still physically present, i.e., the communications are in a format in which the SMIB 132 is programmed to understand. Thus, in general, any communications that the SMIB 132 is programmed to receive from one of the peripheral devices may be emulated by the SIB 130a. The communications that the SMIB 132 may be programmed to understand can be initiated by the peripheral device (e.g., the card reader 126 may send a message to the SMIB 132 when a card is detected) or in response to a command, data, instructions sent by the SMIB 132 to one of the peripheral devices (e.g., the SMIB 132 may poll the card reader 126 to determine whether a card has been detected and in response, may expect the card reader 126 to respond with a message such as ‘yes’ or ‘no’ or after sending a message to display on display 124, the SMIB 132, may expect the display 124 to send an acknowledgement message).

SIB 130b may perform device emulation that comprises determining whether the SMIB 132 expects a particular communication in response to a particular event and if so, determining the contents and format of the expected communication. The communications may be formatted to be consistent with a communication protocol that the SMIB 132 is programmed to understand (e.g., an integer versus a real number, message length, message header, message format, etc.). Further, the communications may be formatted to satisfy the physical requirements of the communication path 146 (e.g., voltage levels, etc).

The expected responses that are emulated by a SIB may vary from SMIB to SMIB depending on the type of device or devices that are associated with the SMIB. For example, a first SMIB may be configured to communicate with a first type of display, first type of card reader and a first type of key pad while a second SMIB may be configured to communicate with a second type of display, second type of card reader and second type of key pad. Thus, a SIB configured to communicate with each of these SMIBs may be required to emulate different responses because of the different device types. In some embodiments, a SIB may be configured to communicate with a plurality of devices of the same type, such as a plurality of different types of displays, which may allow a SIB to be used with SMIBs of varying types.

As an example, the card reader 126 may detect a card-in event and in response send one or more message to the SMIB 132 indicating a card has been inserted in the card reader and what data has been read from the card. In response, the SMIB 132 may send one or more messages to a display commanding the display to display a message, such as, “Welcome player ‘A’, please enter your PIN via the key pad,” in response, the SMIB 132 may expect from the display one or more messages, such as but not limited to, an acknowledgement followed by a status (e.g., displaying message or message display complete). In addition, the SMIB 132 may begin sending polling message to a mechanical key pad device to determine whether a key has been activated and expect a response to each poll or at least expect the key pad device to report within some time period any data relating to an activation of a number of keys.

In the example above the SIB 130b may receive the messages from the SMIB for the display and key pad, determine a response expected by the SMIB 132, generate the response and send the response to the SMIB 132. In the example in FIG. 2, an interface may be generated on the touch screen display 152 including the messages for the display sent from the SMIB 130b, such as the welcome message, and a video key pad 154. The SIB 130b may receive and interpret touch screen data from a touch screen sensor associated with the touch screen display 152 and then convert the data into a format associated with a key pad device for which SMIB 132 is programmed and send it to the SMIB 132. From the point of view of the SMIB 132, it is still communicating with a key pad and display device, such as the mechanical key pad 122 and VFD display 124 described with respect to FIG. 1. After receiving and processing the PIN number, the SMIB 132 may send additional communications to the key pad and the display device. The SIB 130b may receive and respond to these communications.

In one embodiment, the processor on SIB 130b may execute an application that generates the video content for the touch screen display 152. The application may be a media application, such as Flash™ application, downloaded from event server 134 that is executed by a media player, such as a Flash™ player. In one embodiment, the SMIB 130b may communicate directly with the event server 134 via a communication such as a wireless interface. In another embodiment, the SIB 130b may communicate with an event server via the MGC 128. The application executed by the SIB 130b may be an externally controlled interface process as is described below. In other embodiments, the MGC 128 may execute an ECI process that outputs video content to touch screen display 152, such as a flash application, with content that is received from a remote device, such as event server 134.

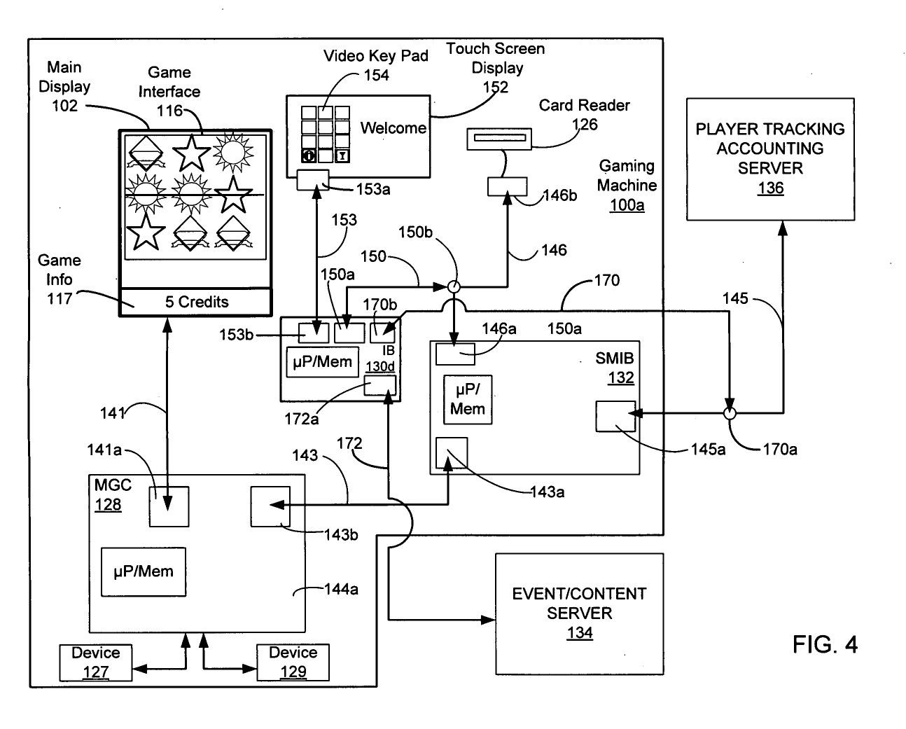

In yet other embodiments, the SIB 130b may act as a memory cache for ECI content for the MGC 128. For example, ECI content may be downloaded to the SIB 130b and stored and then later downloaded to the MGC 128. In addition, as described in the previous paragraph, this content may also be executed on the SIB 130b. The ECI content may download content from a remote device, such as the vent server. Further, ECI content may be downloaded via one of the communication paths associated with SMIB 132 and player tracking server 136 For instance, a connection to communication path 145 (See FIG. 4) may allow the SIB 130b to receive content from the player tracking server 136, a connection to communication path 143 may allow the SIB 130b to receive content from the player tracking server 136 or ECI content may be sent to the MGC 128 and then uploaded to the SIB 130b via communication path 142.

The touch screen display 152 may be used to provide other functions than those provided by SMIB 132. For instance, the touch screen display 152 may be used to provide a bonus application that is not supported by SMIB 132. This application may be executed by the SIB 130b in response to commands, data or instructions received from the MGC 128 and/or event server 134 or may be executed by the MGC 128. In these embodiments, the SIB 130b may be designed or configured to determine that the touch screen display 152 is not being utilized by the SMIB 132 and thus not emulate any devices associated with the SMIB 132. For example, touch screen input received from the touch screen display 152 may not be sent to the SMIB 132.

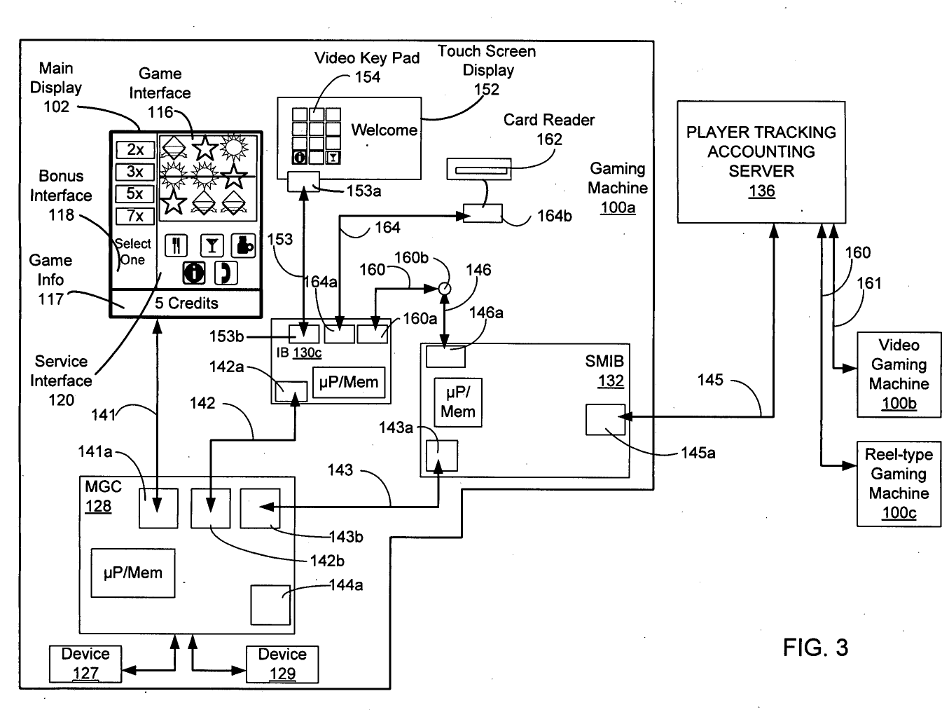

Similarly, if the card reader 126 is emulated by the SIB 130b, as is described with respect to FIG. 3, and the card reader 126 is being used for an application other than receiving a player tracking card, than a card-in event and a card-out event may be reported to a device, such as the MGC 128 or the event server 134 but not the SMIB 130b. This application may require the SIB 130b to block or filter communications as is described below.

As a further illustration of using a card reader for multiple applications, a player tracking card or operator card may be inserted into card reader 126, when a card-in event is detected and it is determined that the card is associated with a player tracking account, the SMIB 132 may be configured to initiate a player tracking session. The player tracking session may continue until the card is removed and a card-out event is detected at which point the player tracking session. During a game play session where a one or more instances of game or games available on a gaming machine are played, the player tracking card may be removed and another card may be inserted into the card reader 126. For example, a debit card may be inserted into the card reader 126 to allow credits to be transferred to or from the debit card.

In one embodiment, the removal of the player tracking card may terminate the player tracking session and the debit card may not be recognized by the SMIB 132 when it is inserted. After the transaction is complete, a message may be generated on the touch screen display or the main display to re-insert their player tracking card to restart the player tracking session. This message may be generated if credits remain on the gaming machine 100a. In another embodiment, the SIB 130b may be configured to block the card-out event from reaching the SMIB 132 so that the player tracking session is not terminated and then may later emulate the card reader associated with the SMIB 132 to generated a card-out event that is compatible with SMIB 132. The SIB 130b may communicate the generated card-out event to the SMIB 132 so that the SMIB terminates the player tracking session.

In yet another embodiment, the SIB 130b may not block the card-out event, but may generate a card-in event compatible with the SMIB 132 after the second card is removed. The card-in event may be generated independent of whether a player tracking card is inserted or not. When the card-in event is generated and sent to the SMIB 132, the player tracking card doesn't have to be reinserted after the second card is removed to start the player tracking session. The card-in event may include player tracking information and card data that was sent from the card reader 126 to the SMIB 132 and received in the SIB 130b via communication path 150. This information may have been stored on the SIB 130b when the player tracking card was first inserted in the card reader. In this example, the SIB 130b may later generate a card-out event that may not be associated with a card removal and send it to the SMIB 132 to trigger the SMIB 132 to end a player tracking session.

In the instances where a device may be utilized by an application associated with the SMIB 132 and an application not associated with the SMIB 132, then the SIB 130b may be designed or configured to determine under what circumstances an application is given control of the device. For example, if the touch screen display 152 is being used to display video content associated with an attract application executed by the MGC 128 and a player tracking card is inserted in card reader 126, the SMIB 132 may generate and send a welcome message for output to a display device. In one embodiment, the SIB 130b may receive this message and decide that the welcome message associated with the application executed by the SMIB 132 is to be given priority and the video content associated on the touch screen display 152 may be terminated. In another embodiment, the SIB 130b may determine that the video content that is currently being output to the touch screen display 152 is more important than the welcome message and may allow the application that is sending output to the touch screen display 152 to continue sending video content to the display. However, although the welcome message is not displayed, the SIB 130b may send a response to the SMIB 132 indicating that has been displayed. In yet another embodiment, the SIB 130b may provide a message queue where the message received from the SMIB 132 is stored for a time period while the application currently outputting content to the touch screen display completes at which point the SIB 130b may output, the message from the SMIB 132. Prior to outputting the message, the SIB 130b may send an expected response to the SMIB 132 so that the SMIB may continue to function normally. Details of process prioritization that are applicable to embodiments illustrated herein are described in U.S. Pat. No. 6,997,803, by Lemay, et al, titled, VIRTUAL GAMING PERIPHERALS FOR A GAMING MACHINE, which is incorporated herein in its entirety and for all purposes.

In general, device emulation may be used to allow other devices not associated with the SMIB 132 to perform functions of devices associated with the SMIB 132 via emulation of events generated by the devices associated with the SMIB. For example, the SMIB 132 may initiate a player tracking session after successfully processing data from a card-in event received from card reader 126 and communicating with the player tracking account server 136. A card-in event may be emulated by SIB 130a when a card is not inserted into card reader 126 to trigger a start of a player tracking session. The card-in event may be emulated when player tracking information is entered via another input device. For instance, player tracking information could be entered in the gaming machine 100a via a touch screen interface on the main display 100a, via a ticket voucher inserted in a ticket acceptor or via a wireless interface that receives information from a device carried by a user.

The SIB 130b may be configured to receive player tracking information from another source, such as from the MGC 128, and format the information to emulate a card-in event received at card reader 126. Then, the SIB 130b may send the information to the SMIB 132. In this embodiment, the SIB 130b may be configured to block communications from the SMIB 132 to the card reader 126 on communication path 146. Communications may need to be blocked so that if the SMIB 132 sends one or more follow messages to the card reader 126 in response to the card-in event, the card reader doesn't respond with a message indicating that a card is not inserted. The card message from the SMIB 132 to the card reader 126 or response messages from the card reader 126 to the SMIB 132 may be blocked to prevent an occurrence of an error condition. To block communications, SIB 130b may be interposed on a communication path between the SMIB 132 and a peripheral device such that all the communications between the SMIB and the peripheral device pass through the SIB 103b.

The SIB 130b may be designed or configured to emulate a card-out event. In the example above, a card-in event was emulated to allow a player tracking session to be initiated using a device other than the card reader. During the player tracking session, the SMIB may determine player tracking points from one or more parameters associated with gaming activity on the gaming machine 100a that are received from the MGC 128 via communication path 142, such as but not limited to an amount wagered. The SMIB 132 may be designed to terminate a player tracking session when a card-out event is detected. After the card-out event is detected, the SMIB 132 may stop its calculation of player tracking points and sending updates of the calculated player tracking points to server 136. When the player tracking session is terminated, the SMIB 132 may continue to send metering data to device 136, which measures gaming activity on the gaming machine 100a. However, the gaming activity may no longer be converted to player tracking points and associated with a particular player tracking account.

Since the card-in event is triggered even though an actual card is not inserted, another event other than a removal of a card may be used to trigger an emulation of a card-out event. An example of another event that is used to trigger the card-out event may be a zero credit condition being reached on the gaming machine 100a. After the zero credit condition is detected, the card-out event may be generated by the SIB 130b and sent to the SMIB 132, which may trigger the SMIB 132 to terminate the player tracking session. To generate the card-out event, the SMIB 130b may emulate a card reader. The player may continue their game play session by providing cash or indicia of credit but additional player tracking points may not be earned for this game play unless a card-in event is detected by the SMIB 132 prior to game play commencing using the additional credits.

In one embodiment, the SIB 130b may be configured to generate a card-in event to trigger in the SMIB 132 to start of a player tracking session. For instance, if the card-out event is generated in response to the zero credit condition being detected, a new card-in event may be generated and sent to the SMIB 132 if new credits are deposited within some time period after the zero credit condition is detected. If an actual player card is inserted into card reader 126 during this time period, than the SIB 130b may not emulate the card-in event.

In another example, the card reader 126 may be used for another application other than an insertion of a player tracking card. For instance, the card reader 126 may be used to read data from a debit card that allows credits to be deposited on the gaming machine 100a. In this example, the SIB 130b may be configured to determine that a debit card has been inserted into the card reader 126 and then block communications from the card reader 126 to the SMIB 132 relating to the card-in event so that the SMIB 132 doesn't process the event as an insertion of a player tracking card.

In general, as mentioned above, the SIB 130a may be designed or configured to perform message filtering and routing where communications from the SMIB 132 to a device may be routed to another destination or prevented from reaching the device and where communications from a device to the SMIB 132 are routed to another destination or blocked. To enable this implementation, communications to and from the SMIB 132 may be routed through SIB 130b. For instance, although not shown in FIG. 2, the SIB 130b may be interposed on the communication path 146 such that communications between end point 146b on the card reader and endpoint 146a on the SMIB 132 are routed through the SIB 130b. With the SIB 130b located on the communication path in this manner, communications between one or more devices and the SMIB 132 may be re-routed or filtered depending on the application.

FIG. 3 is block diagram of an embodiment of a gaming system including a SIB 130c coupled to a master gaming controller 128 and a communication path 146 associated with a slot machine interface board 132 where the secondary interface board provides device emulation and control. In this example, a card reader 162 is connected to the SIB 130c via communication path 165 and communication interface 164a and 164b. The SIB 130c is connected to the communication path 146 via communication path 160 and communication interface 160a and 160b, which allows for communications between the SMIB 132 and the SIB 130c. In this example, the event server 132 shown in FIGS. 1 and 2 is not shown connected to the MGC 128.

In this embodiment, the card reader 162 may be a similar type of card reader as card reader 126 described with respect to FIGS. 1 and 2. Thus, the SIB 130c may not need to emulate the card reader 162 and may only route communications between the card reader 162 and the SMIB 132 via communication paths 164 and 160. Further, as described above, the SIB 130c may provide communication filtering where some communications from card reader 162 may not be received by the SMIB 132 as a result of the filtering. In other embodiments, the card reader 162 may be different than a card reader type for which the SMIB 132 is configured. In this embodiment, the SIB 130c may emulate the card reader type for which the SMIB 132 is configured to convert communications from card reader 162 to card reader communications understandable to the SMIB 132.

FIG. 4 is block diagram of an embodiment of a gaming system including a secondary interface board 130d coupled to a server 134 and a first (146), second (145) and third (143) communication path associated with a slot machine interface board 132. The first communication path 146, as previously described is between a peripheral device and the SMIB 132. The SIB 130d is configured to provide bi-directional communications on communication path 146 via communication path 150. The second communication path 145 is between the SMIB 132 and the player tracking accounting server 136. The SIB 130d may be configured to receive and/or send communications on this path via communication path 170 and communication interfaces 170a and 170b. The third communication path 143 is between the SMIB 132 and the MGC 128. The SIB 130d may designed to receive and/or send communications on this communication path via communication path 174 and communication interfaces 174a and 174b.

In this example, the SIB 130d may be connected directly to an event server 134 but not the MGC 128. Nevertheless, this example is provided for illustrative purposes only as the functions of the SIB 130d described with respect to this embodiment may also be applicable to the embodiments described with respect to FIGS. 1-3. For example, the embodiments described with respect to FIGS. 1-3 may also include connections to the second and third communication paths described with respect FIG. 4. In general, a SIB may be coupled to one or more of the connections associated with a SMIB, such as 132. Further, the functions described with respect to SIBs 130a, 130b, 130c, may be applicable alone or in combination with the functions of SIB 130d described with respect to FIG. 4. For example, the SIB 130d may be designed or configured to be interposed between server 136 and SMIB 132 such that the SIB 130d may filter and reroute communications between these two devices on communication path 145. Further, the SIB 130d may be designed or configured to be interposed between the SMIB 132 and the MGC 128 such that SMIB 130d may filter and reroute communications between these two devices on communication path 143.

In particular embodiments, in regards to communication path 145, the SIB 130d may be designed to only receive communications or send and receive communications. In the embodiment where SIB 130d is designed to send communications, the SIB 130d may be designed or configured to emulate one or more communications associated with SMIB 132, to emulate one or more communications associated with player tracking server 136 or combinations thereof. Thus, in this embodiment, the SIB may emulate the server 136 so that functions of the SMIB 132 that may be triggered in response to commands, instructions or data received from the player tracking and accounting server 136 may also be triggered in response to commands, instructions or data received from the SIB.

As a first example of device emulation related to communication path 145, a command to place the gaming machine in a bonus state may be triggered from commands, instructions sent from device 136 to SMIB 132. In one embodiment, the SIB 130d may be operable to receive commands, instructions or data from a remote device, such as server 134, for triggering a bonus state and then emulate the server 136 on communication path 145 so that the SMIB 132 triggers the bonus state on the MGC 128 via communication path 143. In another example, the SMIB 132 may be operable to download credits from server 136 to the MGC 129 via communication paths 145 and 143. In one embodiment, the SIB 130d may receive credits for download from server 134 and then emulate server 136 to the SMIB 132 on communication path 145 so that the SMIB 132 downloads the credits to the MGC 128.

In yet other embodiments, the SIB 130d may be able to receive communications between the MGC 128 and the SMIB 132, extract data from these communications and post it as an event and event information that may be received by another device, such as server 134. For instance, when a jackpot or award is triggered on MGC that is over a certain amount, the SIB 130d may be configured to send an event and event information to the event content server 134. In response to receiving the event, the event content server may send commands, instructions or data related to generating video content on touch screen display 152. For example, a flash application may be downloaded from server 134 to SIB 130d that is executed by SIB 130d. In one embodiment, the video content may be a celebratory animation and message. In another embodiment, video content may be associated with an offer. The offer may be purchased using the award that the player has just won where the touch screen display 152 is used as an interface to purchase the award. In one example, an offer to purchase a lottery ticket or make a sports wager may be made utilizing video content provided via an application such as a flash application.

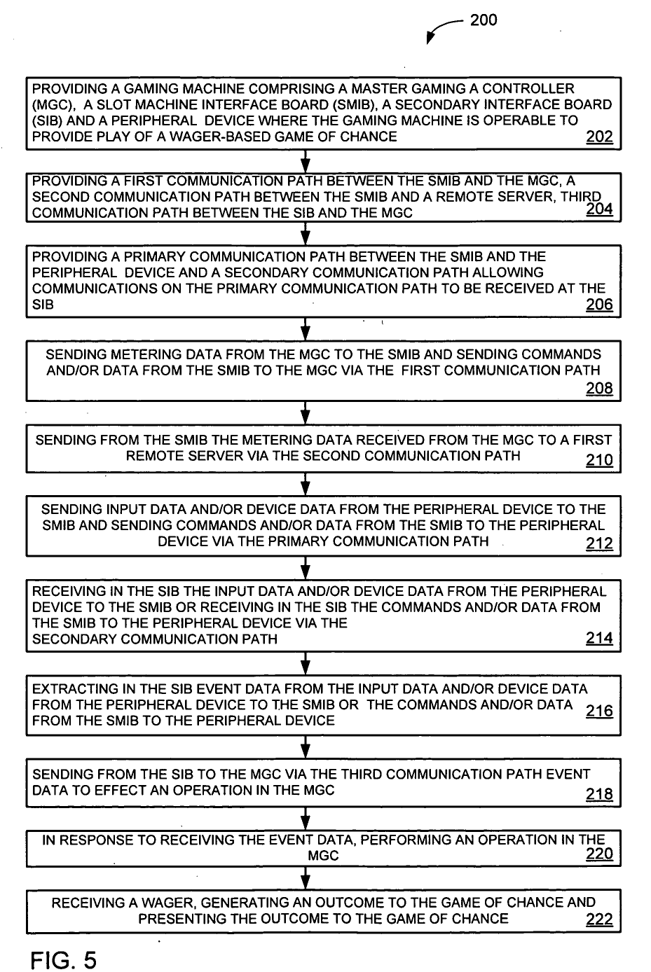

FIG. 5 is flow diagram of method of providing communication in a gaming machine using a secondary interface board (SIB) coupled to a master gaming controller (MGC) and a slot machine interface board (SMIB). In 202, a gaming machine comprising a master gaming a controller (MGC), a slot machine interface board (SMIB), a secondary interface board (SIB) and a peripheral input device may be provided. The gaming machine may be operable to provide play of a wager-based game of chance. In some embodiments, the gaming machine may be configured to determine an outcome for the game of chance, accept cash or indicia of credit that is converted to credits for the purposes of wagering on the game of change and control dispensing of cash or an indicia of credit redeemable for cash or additional game play.

In 204, a first communication path between the SMIB and the MGC, a second communication path between the SMIB and a remote server, such as a server providing accounting and/or player tracking functions, a third communication path between the SIB and the MGC may be provided. The communications paths between the SMIB and the MGC and the SMIB and the remote server may be associated with an accounting and/or player tracking system. In one embodiment, a fourth communication path between the SIB and a remote device may also be provided. In another embodiment, the third communication path between the SIB and the MGC may be omitted. For instance, the SIB may only communicate directly with a remote device, such as a remote server and indirectly with the MGC via the remote device.

In 206, a primary communication path between the SMIB and a peripheral device may be provided. Further, a secondary communication path between the SIB and the primary communication path may be provided. The secondary communication path may be configured to allow communications on the primary communication path between the SMIB and the peripheral device to be received at the SIB. The SMIB may be programmed to control the peripheral device including sending commands, instructions or data to the peripheral device and to communicate with the peripheral device. In instances where the peripheral device is an input device, the SMIB may be operable to process data received from the peripheral device including sending data to a remote device, such as a player tracking server. The SMIB may control and communicate with a plurality peripheral devices. A card reader, display device, a mechanical key pad device, an input button, a lighted bezel and an audio device are examples of peripheral devices that may be coupled to the SMIB.

In 208, the MGC may send to the SMIB via the first communication path messages including metering data (e.g., coin-in, coin-out, wager information, jackpot information, etc.) and machine status information (tilt status, door status, need service, etc.). In addition, the SMIB may send commands, instructions and/or data to the MGC via the first communication path. For instance, the SMIB may be configured to trigger a bonus condition on the gaming machine via commands, instructions and/or data sent to the MGC.

In 210, the SMIB may send metering data received from the MGC to a first remote server, such as a player tracking accounting server via the second communication path. Further, the SMIB may send data received from a peripheral device via the primary communication path to the first remote server via the second communication path. For instance, the SMIB may receive player tracking information read from a card inserted into a card reader via the primary communication path and send it to the first remote server via the second communication path. In another example, the SMIB may be operable to determine player tracking points and send the point values to the first remote server via the second communication path. In yet another example, the SMIB may receive a drink request which may be sent to the first remote server via the second communication path. In addition, via the second communication path, the SMIB may receive from the first remote server commands, instructions or data, such as but not limited to a player's name associated with a player tracking account, credits to transfer to the MGC, a point total associated with a player tracking account, a command to effect an operation on a gaming machine, such as to trigger a bonus condition on the gaming machine.

In 212, via the primary communication path, input data and/or device data received or generated at the peripheral device may be sent to the SMIB. In addition, the SMIB may send commands, instructions and/or data to the peripheral device via the primary communication path. In 214, the SIB may receive the input data and/or device data sent from the peripheral device to the SMIB or may receive commands, instructions and/or data sent from the SMIB to the peripheral device via the secondary communication path.

In 216, the SIB may extract data from the input data and/or device data sent from the peripheral input device to the SMIB or the commands and/or data sent from the SMIB to the peripheral input device. The SIB may generate an event and associated event information from the extracted data. In 218, the SIB may send the event data and event information another device, such as the MGC and/or a second remote server. In 220, the SIB may send to the MGC via the third communication path an event including event information to effect an operation on the MGC.

In 220, response to receiving the event, the MGC may perform an operation. The operation may be performed by the MGC in conjunction with information received from a remote device, such as a flash application downloaded from the remote device. The MGC may execute a flash player in a display device coupled to the MGC, as described in the following sections, to run the flash application. In particular embodiments, the flash application may output video and/or audio content that enhances a function associated with a player tracking unit and/or system. For instance, the enhanced function may be a welcoming message associated with a player, a bonusing application associated with a bonus function of the player tracking unit, an interface for reading metering information stored on the player tracking unit or a service application associated with a service function of the player tracking unit. In 222, a wager may be received, an outcome to the game of chance may be generated and the outcome to the game of chance may be presented on the gaming machine. The operation effected on the gaming machine by the event downloaded by the SIB may be performed while the gaming machine is operable to generate a game of chance.

Externally-Controlled Interface Processes

In particular embodiments, the gaming devices on the gaming machine may be controlled by software executed by a master gaming controller 46 (see FIG. 1-4, 7A, 7B and 8) on the gaming machine in conjunction with software executed by a remote logic device (e.g., a remote host, a central server or a central controller) in communication with the gaming machine. The master gaming controller and/or other gaming devices, such as a secondary interface board (SIB), may execute externally-controlled interface (ECI) processes, described in more detail below, that enable content generated and managed on the remote host to be output on the gaming machine. The gaming machine may receive and send events to the remote host that may affect the content output by one or more ECI processes as well as enable an ECI process to be initiated on the gaming machine.

The master gaming controller may be configured to limit the resources that can be utilized by the ECI processes executing on the gaming machine. Specific resource limitations may be predetermined, negotiated with a host device controlling an ECI prior to the execution of the ECI on the gaming machine or combinations thereof. To enforce any established resource limitations, the master gaming controller may constantly monitor resources utilized by the ECI processes and other gaming processes executing on the gaming machine.

The ECI's may be executed while a gaming machine is operable to provide a play of wager-based game of chance (During operation, one or more games and one or more executed simultaneously, one or more games may be executed without execution of an ECI or one or more ECIs may be executed while a game is not being played). Therefore, the resources may be limited to ensure that a gaming experience on the gaming machine is optimal while access to gaming resources is granted to a remote host. The resources allocated to ECI's may be limited for many reasons, such as ensuring the game play experience is adequate or for security purposes, and the examples described herein, which are provided for illustrative purposes only. For instance, the CPU cycles provided to executing ECI processes may be limited to ensure a minimal graphically rendered frame rate is maintained on the gaming machine. As another example, the ECI processes may not be allowed to directly control or access certain devices, such as money handling devices, to prevent the ECI from allowing cash or an indicia of credit to be input or output from the gaming machine.

It should be appreciated that the gaming device resources utilized by the ECI processes include, but are not limited to: graphic resources of the gaming machine (i.e., what graphical real estate is available on the display device without interfering with the graphics of the primary game), audio resources of the gaming machine (i.e., what audio content may be provided by the gaming machine without interfering with the audio of the primary game), timing resources available (i.e., has the primary game ended or is the primary game beginning), and/or CPU processing resources of the gaming machine. In one embodiment, access to such resources may be based on a priority system configured to maximize an optimal gaming experience for each player.

In particular embodiments, the host-controlled ECI processes may be decoupled from the processes used to generate the game of chance played on the gaming machine such that the content output by the host-controlled ECI processes doesn't alter the play of game of chance. Thus, the logic for the game processes may be designed such that information regarding the state or content generated by the ECI processes is not needed to generate the game of chance and/or the game and related processes may not recognize any information produced by the ECI's. The ECI processes may be designed in a similar manner.

An advantage of ECI software and game software decoupled in this manner may be that content may be provided from a remote host that enhances the functionality and features available on the gaming machine. The content can be easily varied with little or no modification to the gaming software resident on the gaming machine. For instance, many features and services on a gaming machine can be provided using a generic ECI that enables access to a display and a touch screen on the gaming machine. Externally controlled interfaces, the interaction between a remote host and a gaming machine, embodiments of hardware and software architectures on a gaming machine related to ECI's are described with respect to the following figures.

FIGS. 6A to 6C are block diagrams illustrating an interaction between a host and gaming machine for one embodiment of the present invention. In FIG. 6A, a block diagram of a gaming system comprising a gaming machine 100, a remote host 110 and a network that enables for communication between the gaming machine and the remote host 100 (not shown) is illustrated. The gaming system is provided for illustrative purposes only. Gaming systems comprising multiple gaming machines and multiple remote hosts are possible. Further, in some embodiments, the gaming machine 100 may perform functions of the remote host 100 or the remote host 110 may be a game server providing games that are output on other gaming devices or the remote host 110 may be a gaming machine similar to gaming machine 100. Further details of embodiments of gaming systems and gaming devices that may be used are described with respect to the preceding and following figures

The gaming machine 100 comprises a touch screen display 102 that may be a component of a game interface 116. The game interface 116 comprises the components on the gaming machine 100, such as input buttons (not shown), audio output devices (not shown), etc., that enable a game to be played on the gaming machine 100. An operating system 104 executes a number of processes including game logic 106 for providing a game on the game interface 116, event logic 108 and communication logic for communicating with the remote host 110 (not shown).

In FIG. 6A, the game interface 116 may be divided into two regions on the touch screen display 102. A first region includes symbols and paylines for a video slot game. A second region 117 includes game information including the number of credits available for wagering on the slot game. In the game state illustrated in the figure, five credits are available for wagering.

The remote host 110 comprises a processor, memory and a communication interface (each not shown). Content 114 that may be output on the gaming machine 100 and event logic 112 that enables the remote host 110 to respond to events and information received from the gaming machine and/or generate events to send to the gaming machine 100. Additional details of remote hosts are described with respect to U.S. patent application Ser. No. 11/595,774, previously incorporated herein.

In FIG. 6A, the event logic 108 detects an event message and sends an event message with information describing the event to the remote host 110. As is described with respect to FIG. 1B, the remote host 110 responds to the event by requesting the gaming machine to launch an externally controlled interface (ECI) that enables content 114 stored on the remote host 110 to be output on the gaming machine. A few examples of events occurring on the gaming machine 100 that may trigger an instantiation of an ECI to be launched on the gaming machine 100 include but are not limited to (1) a deposit of credits on the gaming machine, (2) a player tracking card inserted into a card reader, (3) information being read from a portable instrument carried by a player (e.g., a cell phone, RFID tag or other wireless device), (4) an actuation of button, such as a mechanical button or a touch screen button, (5) an event triggered from a play of the game 106, (6) a cash-out command detected on the gaming machine, (7) an input of a wager, (8) an initiation of the game 106, (9) a number of credits available on the gaming machine, (10) the result of one or more games, (11) the result of the generation of one or more symbols, (12) a designated win amount, (13) a player cashing out available credits, and (14) a player tracking card removed from a card reader. As is described in more detail with respect to U.S. patent application Ser. No. 11/595,774, filed Nov. 10, 2006, and titled, “Method and Apparatus for Integrating remotely-hosted and locally rendered content on a gaming device,” and U.S. patent application Ser. No. 12/209,608, filed Sep. 12, 2008, and titled, “Gaming Machine with Externally controlled content display,” each of which is incorporated herein in their entirety and for all purposes, an event generated on the remote host may also trigger the launch of an ECI on the gaming machine.

The event sent from the gaming machine is evaluated by the event logic 112 on the remote host 110. In response to the receiving the event 110, the remote host 110 sends a message requesting access to resources on the gaming machine 100. In response, the gaming machine 100 may send a message to the remote 110 describing the resources it has available for external control and any usage limitations that are associated with the resources, such as a portion of the display 102 including its dimensions that may be utilized by the remote host.

The remote host 110 may use the resource information provided by the gaming machine 100 to determine what content to send to the gaming machine 100. For example, video content to be output on the portion of the display 102 allocated for use by the remote host may be generated and/or selected to be compatible with the size of the display window. The process of establishing a resource sharing arrangement between the remote host 110 and the gaming machine 100, which may involve a negotiation between the remote host 110 and gaming machine 100, are described in further detail with are described with respect to U.S. patent application Ser. No. 11/595,774, previously incorporated herein.

In FIG. 6B, a state of the gaming machine 100 and the remote host 110 is illustrated where the gaming machine 100 has launched two ECI's, 122 and 124, that enable the remote host 110 to output content for a bonus interface 118 and a service interface 120 on touch screen display 102. The bonus interface 118 may be just one example of an interface that may be provided. A multimedia player, such as a Flash Player™ by Adobe™ (Adobe Systems Incorporated, San Jose, Calif.), may be one example of software that may be used as an ECI, such as 122 and 124. The multimedia player may allow, as one of its features, multimedia content received from the remote host 110 to be displayed on the touch screen display 102 and/or output on other gaming devices, such as speakers coupled to the gaming machine.

The remote host may download the multimedia content as part of application files that are utilized by the ECI's, 122 and 124. The application files may include embedded content, data, scripts and other instructions for accessing the capabilities of the ECI to be utilized. For example, the Flash Player™ runs and/or parses flash files which may include Adobe Flash Action Script.™ The flash files may include information relating to utilizing raster or vector graphics, a scripting language to control functions of the player and information for providing bidirectional streaming including audio and video information. In particular, an ECI may be operable to receive video and/or audio streaming of content from a remote host. The multimedia player and associated files, such as the Flash Player™ may be a component of a “Rich Internet Application,” (RIA).

Rich Internet applications (RIA) are typically interface applications provided by a host to a client with downloadable components that have the features and the functionality of locally installed and executed programs. RIAs typically transfer the processing necessary for the interface generated by the application to the client but keep the bulk of the data (i.e., maintaining the state of the program, the data etc) back on the host. RIA's are not limited to web-based applications applied over the Internet and may be utilized in other network architectures. In an RIA involving a host device and a client device (e.g., remote host 110 may be considered a “host” and gaming machine 100 may be considered a “client” in particular embodiments), an application for generating an interface executed on the client may be operable to perform functions independently of the host, such as computations, send and retrieve data in the background, store data locally, redraw sections of the screen, and/or use audio and video in an integrated manner, etc.

The application for generating the interface may also share data with other applications locally executing. For example, two ECIs executing on gaming machine 100 may share data. The shared data may affect the content displayed on one or both ECIs. In particular embodiments, the ECIs may be prevented from directly sharing data with other processes executing on the gaming machine. For example, to share data with a non-ECI process, the ECI may have to send the information to the remote host first, which then may or may not perform additional processing on the data before communicating it back to the gaming machine.

Returning to FIG. 6B, after the ECI's, 122 and 124, have been launched by the operating system 104, the touch screen display 102 may be divided into four regions. The game interface 116 may be displayed in a first region, the bonus interface 118 may be displayed in a second region, the service interface 120 may be displayed in a third region and the game information 117 in a fourth region. The game interface 116 is configured to fit in a smaller region as compared to FIG. 1A, which may affect the graphical presentation of the game and may affect a mapping of touch screen buttons to the display 102 associated with the game interface 116.

In general, a master gaming controller in the gaming machine may be operable to provide content to display regions of different sizes. To provide content to display regions of different sizes, the gaming machine may perform one or more of the following, 1) select from among stored content, such as bitmaps, movies, animations, geometric models, etc., according to which content is more appropriate for a given display size, 2) rearrange a position of one or more components in a display window relative to one another, 3) scale content, 4) stretch content, 5) interpolate content, 6) generate new content, 7) adjust parameters of a 3-D graphical environment used to generate content and 8) combinations thereof.

In one embodiment, the wager-based games played on the gaming machine may be configured such that the manner in which a game is played or the manner in which an outcome is generated for the game may not be altered via any information from any instantiation of an ECI on the gaming machine 100. For example, in one embodiment, the bonus interface 118 may be used to provide a bonus multiplier for an award associated with an outcome of a game played on the gaming machine, such as a ten times bonus. In this example, the bonus multiplier doesn't affect how the game is played or how the outcome to the game is generated. But, the bonus multiplier does affect the award for the game, i.e., it is multiplied by a factor of ten.

In the example described in the preceding paragraph, the gaming program may include logic to generate a simple message that a bonus multiplier has been provided, such as a simple text message “You have won a bonus Multiplier.” The bonus interface ECI 118 may be used to enhance and customize the presentation of the award of the bonus multiplier. For instance, in a particular embodiment, the bonus multiplier may be provided by a local casino and bonus interface ECI 118 may be used to display one or more of a casino logo, a custom message from the casino and a theme based presentation, such as a casino theme or a holiday theme as part of a presentation for the bonus multiplier award.

In many gaming jurisdictions, after a game is approved, the content of the game may not be altered. Thus, to customize a game for a particular casino or a particular gaming entity, customized content would have to be added to the game and then submitted to an associated gaming jurisdiction for approval at which point the content would be fixed (Gaming jurisdictions don't allow the gaming software to be altered in any way after it has been approved). The approval process is time consuming and expensive.

Prior to the approval process for a particular game, the gaming software provider for the particular game often doesn't know which casinos or other gaming entities are going to purchase the particular game. For instance, game purchasers often wait and see how the particular game is performing at other casinos before they choose to buy it. Thus, the desire for a customized version of the particular game generally arises after the content of the game has been fixed by the approval process. To provide desired customization after the approval process, the customized game would have to be resubmitted for approval, which is very expensive.

One advantage of using ECIs is that a presentation of a game may be enhanced using an ECI, such as by providing a presentation for a bonus multiplier, as described above, in conjunction with the presentation of the game. The content of the ECI may be customized and altered after the release of the game while the presentation provided by the game may not be altered after its release. The presentation provided via an ECI may be designed to look like a component of an associated game, e.g., it may use the same theme and may be displayed on the same screen, and thus, to the player may appear as another component of the presentation of the associated game even though as will be discussed further, the ECI may be a logical entity decoupled from the associated game. Thus, using an ECI, the appearance of game customization may be provided to a user without having to customize the actual game that is submitted for jurisdiction approval.

In yet another embodiment, the gaming device utilizes a plurality of display devices to display the game interface and one or more ECIs. For example, a first display device may display the game interface and a second display device may display each ECI communicated from the remote host. In one such embodiment, each display device may be controlled by one or more different processors such that each display device may generate and display information or data independently of (or alternatively dependent on) information or data displayed by the other display devices.

In another embodiment, the remote host may be in communication with each such processor to oversee (and possibly control) what may be displayed on one or more display devices of each gaming device in the gaming system. In this embodiment, the remote host may be either in direct communication with or indirect communication with (such as through a player tracking system) each gaming device in the gaming establishment. This configuration provides that even if the remote host is not directly in communication with a designated gaming device's CPU, the remote host may be still operable to communicate with and provide such designated gaming device (and all gaming devices in the gaming establishment) one or more ECIs as described herein. Examples of display devices that may be controlled via an ECI are described with respect to U.S. application Ser. No. 10/756,225, filed Jan. 12, 2004, entitled, “Virtual Glass for a Gaming Machine,” by Lemay, et al, which is incorporated herein in its entirety and for all purposes.

The bonus interface 118 may enable a player to win a bonus award. In one embodiment, a player may be afforded an opportunity to select between a number of bonus multipliers where a probability of an award of the selected multiplier varies from multiplier to multiplier and may be calculated based upon which multiplier is selected. In one embodiment, the logic for determining whether the selection of a particular multiplier may reside on the remote host 110. In another embodiment, the logic for determining the selection of a particular multiplier resides on the remote host and uses data communicated from the gaming device, such as data based on a player tracking information.

When the player selects one of the multipliers, raw touch screen input data may be sent via event logic 108 and using necessary communication logic (not shown) to the event logic 112 on the remote host 110. When the ECI 122 for the bonus interface 118 is instantiated, a portion of the touch screen display 102 that may be used by the ECI 122 may be determined. This information provides a mapping in regards to which regions of the display are assigned to ECI's. With this information, the operating system 104 may determine whether a touch input received at a particular location is in a region assigned to an ECI and when it is determined that the input is in a region assigned to a particular ECI, route the touch information to a remote host controlling the particular ECI.

In another embodiment, the ECI, may be designed or configured to perform some data handling received from the touch screen. For instance, the ECI may be configured to receive raw touch screen data and determine whether a button has been activated. It may be possible to specify, prior to execution of the ECI what portion of a display screen is available to the ECI and its associated dimensions/coordinates. Thus, a remote host, such as 110, may download an application file including desired content for use by the ECI, such as 122 and 124, that allows the ECI to process touch input. For example, the application file may include a mapping of coordinate locations for each active area (i.e., an area for accepting touch inputs such as buttons on displayed on the display behind the touch screen). The mapping may allow the ECI to process the raw touch data and then send higher-level information to its external controller, i.e., host 110, such as, “Button A activated.”

Input processing logic may be provided with an ECI for input devices other than a touch screen. For instance, as part of an instantiation of an ECI controlled by a first remote host, it may be agreed that when input from one or more input devices, such as a touch screen, card reader, a mechanical key pad, mechanical input buttons and combinations thereof, is detected, the input information is to be sent to the first remote host as long as the ECI is active or sent to the ECI for processing, which then may forward the processed information to the remote host. Thus, in general, as part of the initial instantiation of an ECI, information regarding what input devices are associated with the ECI and/or what types of input information to route to the ECI and/or to route directly to the remote host associated with the ECI may be determined and stored on the gaming machine. The information regarding what input devices are associated with the ECI may be determined during an initial negotiating process between the host and the gaming machine.

In another embodiment, the ECI may provide initial processing of information. For example, during the negotiation process, the gaming machine may specify information regarding inputs it receives from various input devices that it will share with the ECI. The specified information may include but is not limited to the type of device, manufacturer of the device, one or more inputs generated from the device and a format for the information for each the inputs. Using the specified information, the remote host may generate application files for an ECI or generate a new ECI application that performs the proper processing/filtering of the inputs received from the gaming machine and routes needed information to the remote host or remote hosts associated with the ECI.

As described in the previous paragraph, the gaming machine may not pass along information regarding all of the inputs it receives from devices coupled to the gaming machine. For instance, the gaming machine may not pass along input information generated by a bill validator or money handling devices coupled to the gaming machine. In one embodiment, the gaming machine may include logic for providing a standard set of device descriptions and associated inputs that may be provided to an ECI. In another embodiment, the gaming machine device descriptions and associated inputs may be varied depending on the remote host that is requesting resources for an ECI. Further details are described with respect to FIGS. 2-7.

As described above, even when the remote host or ECI is to receive input from an input device, not all of the input information received from an input device may be routed to the ECI and/or the remote host controlling the ECI. For instance, the remote host may specify that information read from a player tracking card is to be sent directly to the remote host or routed through the ECI but not information from a credit card. As another example, the remote host may specify that it is looking for input only from a portion of the mechanical input buttons on the gaming machines and that only input from the specified buttons is to be directly routed to the remote host or routed through the ECI but not other buttons. In yet another example, the remote host may specify that if the player inserts a ticket into the bill validator while the ECI is active that the gaming machine is to directly route the ticket information to the remote host or route it through the ECI.

Returning to FIG. 6B, after the remote host 110 receives from the gaming machine 100 the raw touch input corresponding to the selection of one of the bonus multipliers, in one embodiment, the bonus interface manager 126 on the remote host 110 determines that the raw touch input corresponds to a selection of the “2×” multiplier illustrated in FIG. 1B. In another embodiment, the raw touch input may be routed to ECI 122, which process the raw touch input and then notifies the remote host that the “2×” multiplier has been selected.

In response to the selection of the “2×” multiplier, the bonus interface manager may send updated content to gaming machine 100 that indicates the “2×” multiplier was selected, which may be displayed by the ECI process 122 to the display screen. For instance, the “2×” multiplier may be highlighted or emphasized in some manner in the bonus interface 118 on the touch screen display 102. In another embodiment, the ECI 122 may have the capability to update the display to indicate the “2×” multiplier has been selected without receiving additional content or instructions from the bonus interface manager 126.

In this example, the bonus interface manager 126 next generates a random number and determines that the player has won the “2×” multiplier. In response, the bonus interface manager 126 sends updated content indicating the player has won the “2×” multiplier, which may be displayed by the ECI process 122 to the display screen. Next, the remote host 110 may send two events to the gaming machine 100 which may be received and processed by the event logic on the gaming machine.

The first event received from the remote host 110 may cause the gaming machine 100 to double the credits in the credit meter stored on the gaming machine. The first event may be processed by event logic 108 on the gaming machine. When the credit meter has been doubled, as shown in FIG. 6C, the gaming machine 100 may send a message to the remote host 110 indicating the amount credited to the player. Both the gaming machine 100 and the remote 110 may store a record of this event (i.e., the award of the additional credits) for auditing and dispute resolution purposes to secure memory location, such as a Non-volatile memory. It should be appreciated that this first event illustrates an occurrence of an ECI (in this case, a 2× multiplier) modifying one or more aspects of the locally controlled game of chance.

The second event sent from the remote host 110 causes the gaming machine 100 to close down or hide the bonus interface 118 and terminate the ECI process 122 associated with the bonus interface (see at least FIG. 6C). The remote host 110 terminates the bonus interface manager 126 used to send content associate with the ECI 122 to the gaming machine 100 (see at least FIG. 6C). During the termination process, the gaming machine 100 and remote host 110 may exchange messages with information indicating the ECI 122 is no longer active and session termination information, such as a session associated with the ECI 122 ended at a certain time, date, etc.

In one embodiment, the gaming machine enables the player at least partial control in when to open and close down (or hide) the ECI. In one such embodiment, a player may open and close an ECI via a button connected to (or otherwise associated) with the remote host. In this embodiment, the master gaming controller may receive a message from the remote host indicating a desire to close down or hide the ECI. In another embodiment, a player may open and close an ECI via a button connected to (or otherwise associated) with the master gaming controller. For example, a dedicated mechanical input switch/button may be provided on the gaming machine that generates a signal indicating a desire to open or close an ECI.

When an ECI is initiated or terminated on the gaming machine, in response to an input from an input device on the gaming machine, such as the actuation of an input switch as described in the preceding paragraph, in response to some other event generated on the gaming machine, or in response to an event generated on a remote host, in one embodiment, the gaming machine may initiate a session with a remote host that is to provide the ECI or terminate a session with the remote host that provided the ECI.

In another embodiment, when a request is received to terminate an ECI, the gaming machine may maintain the session with the remote host but place the ECI into an inactive or hibernating state and notify the remote host of the ECI status. For example, when the ECI is used to output content to a portion of a display and a request is received to terminate the ECI, the gaming machine may display other content in the portion of the display previously utilized by the ECI, such as resizing the game interface to fit into this portion of the display, place the ECI into an inactive state and notify the remote host of its inactive state without terminating the session. When it is later determined that the ECI is to be reopened, the gaming machine may open the ECI in the display again and notify the remote host of the active status of the ECI. At this time, the gaming machine may or may not renegotiate resources for the ECI.

Returning to FIGS. 6B and 6C, after the bonus interface 118 and ECI 122 are terminated, additional resources related to the touch screen display 102 become available on the gaming machine. In this example, ECI 124 associated with the service interface 120 may be still active after the ECI 122 is terminated. Thus, the gaming machine 100 and the remote host 110 may renegotiate the resources assigned to ECI 124.

As is illustrated in FIG. 6C, after the renegotiation of resources, the game interface 116 and/or the service interface 120 may be resized and assigned to different areas of the touch screen display 102. In response, service interface manager 128 on the remote host 110 generates new content from the content 114 stored on the remote host 110 for the service interface 120 that is consistent with the new display area. In particular, the icons displayed in the service interface 120 may be rearranged as compared to FIG. 6B, to fit into the new display region and the remote host 110 may generate a new touch screen mapping that corresponds to the rearranged icons. The remote host 110 downloads content, information, applications files, etc, to the gaming machine to implement or all or a portion of the specified changes. The content provided from the remote host may be output on the gaming machine 100 via the ECI 124 associated with the service interface 120.

As illustrated in FIGS. 6B and 6C, the service interface 120 includes a number of icons that enable a user to select a service. These icons include food, drinks, coffee, information and communications with another person, such as another game player or a concierge associated with a casino. The types of icons displayed may depend on personal preferences and game play habits of the game player at gaming machine 100 as well operating conditions specified at the casino. For instance, a more valued game player may have access to food, drinks and coffee while a less valued game player may have access to only drinks and coffee. Accordingly, for the less valued game player, the food icon would not be displayed on the service interface 120. Additional details regarding service interfaces are described in U.S. patent application Ser. No. 11/595,774, previously incorporated herein.

To personalize an ECI, such as 124, if the remote host 110 does not store player information, the remote host 110 may receive player information from another gaming device, such as a player tracking server, that enables the ECI's controlled by the remote host to be personalized. The player information may include information regarding game play history for a particular player. In addition, while games are being played on the gaming machine 100, the remote host 110 may directly receive from the gaming machine 100 or via an intermediary device, game play information, such as wager amounts, amounts won, amounts lost, types of games played, amounts deposited to the gaming machine, number of games played, game started, game completed, etc. The game play information may or may not be associated with a particular player.

When an icon on the service interface 120 is selected, the touch screen input data may be sent to the remote 110 which determines what selection was made, i.e., food, coffee, drink, etc. In response, as further described in U.S. patent application Ser. No. 11/595,774, previously incorporated herein, the service interface manager 128 on the remote host 110 may generate new content to send to the gaming machine 100. For example, in response to a selection of the food icon, new content regarding food choices may be sent to the gaming machine 100. These food choices may be displayed in the service interface 120 region on the touch screen display 102 instead of the icons illustrated in FIGS. 6B and 6C.

After a food choice is selected, in one embodiment, the remote host 110 may contact a casino entity providing the food services and may place an order for the food. When the food is ready, it may be delivered to the gaming machine 100. In another embodiment, after the food choice is selected, the remote host 110 may place an order for the food and instruct the gaming machine 100 to print a ticket and/or display information indicating a time and/or a location where the food may be picked up by the game player.

As previously described, the remote host 110 may download information/content in an appropriate format, such as application files including embedded content, such as video and audio files, and other information and/or instructions for an ECI, such as 122 and 124. The application files may be stored locally on the gaming machine 100. In addition, when resources are available (resource monitoring is described in more detail in U.S. patent application Ser. No. 11/595,774, previously incorporated herein), one or more application files or one or more portions of an application file may be stored on the gaming machine 100 even after an ECI has completed execution.

The gaming machine 100 and/or remote host 110 may include logic in regards to storing or purging files. For example, some commonly used files may be stored permanently, other files may be stored for a certain time period, other files may be stored only as long as a particular ECI is active and other files may be stored as long as storage space is available. In another embodiment, all files may be stored in volatile memory such that the files are purged when the gaming machine powers-up and more persistent storage may be provided by a remote host. When application files executed are downloaded from the host 110 to the gaming machine, the host may provide information that helps the gaming machine manage it applications files. For example, the host 110 may designate some application files that are used regularly or are likely to be needed in the future. The gaming machine may use this information when determining where to store the application file or when determining a purge schedule for application files.

One advantage of saving one or more application files on the gaming machine may be that download times may be reduced. For example, if all or a portion of the application files used to generate the bonus interface 118 used by ECI 122 are stored on the gaming machine after the bonus interface is terminated, then a similar bonus interface 118 may be later instantiated on the gaming machine using the one or more stored application files rather downloading all of the need files in total each time.

Further, in some embodiments, two or more ECIs may be able to share application files or a portion of the data stored in an application file. For instance, a video image for a casino logo may be shared by the bonus interface 118 and the service interface 120. Thus, once the video image of the casino logo is downloaded and stored for either bonus interface 118 or the service interface 120, it may be possible to reduce a size of the download by letting the host 110 know that this video image is already available on the gaming machine. In particular embodiments, the gaming machine 100 or the host 110 may initiate a process where information regarding the application files or other content stored locally on the gaming machine 100 that may be utilized with an ECI is communicated between the remote 110 and the gaming machine 100. The remote host 100 may use this information to determine what information/content/instructions, such as application files or application file components to download to the gaming machine 100.

In yet another embodiment, ECIs, such as 118 and 120 may be operable to directly share information with one another. For example, the bonus interface 118 may allow a player to when a free meal. When a player has won a free meal, the ECI 122 generating the bonus interface 118 may be operable to share this information with the ECI 124 generating the service interface 120. The service interface 120 may be operable to provide dinner reservations. Thus, in response to information received from ECI 122, the service interface 120 may be modified to ask the player if they wish to make a reservation at the restaurant and to display information about the restaurant where the free meal was awarded.

In FIG. 6A-6C, the display screen 102 is divided into a number of portions where the size of the portions and the processes used to provide the content to the portions vary with time. The arrangement of display portions and their associated processes are provided for illustrative purposes only. In a particular embodiment, pixel dimension or screen coordinates for a display portion used to output content may be selected to provide various shapes, such as substantially circular, diamond shaped, triangular shaped, star-shaped, etc. For example, an ECI may be operable to output content to one or more of the diamonds or stars on the game interface 116 in FIG. 6A, 6B or 6C. In this example, the ECI may be operable to display content within a moving symbol. In general, the ECI may be operable to display content within a display portion that moves around the screen. For example, the display portion assigned to the ECI may be a shape that moves, such as appears to bounce and the ECI may output content to this remote shape.

In another embodiment, one display portion may be surrounded or overlap another display portion. For example, a first ECI or other process may output content to a rectangular display portion with a “hole” in it. The hole may simply be another display portion at the location of the hole that is controlled by a second ECI or other process, such as a game process. In one embodiment, the first ECI may be aware of the “hole” and arrange its content so that it does not fall with the hole.

In yet other embodiments, the gaming machine may be operable to provide display portions for utilization by an ECI, as “pop-up” windows that overlap or overlay one or more other display portions. The gaming machine may include logic that prevents a pop-up window from blocking an important gaming component on the display, such as a touch screen input button for a game that is being played, or from blocking important game information on the display, such as an outcome of a game that is being played. Whether the gaming component or the game information is important may vary with time, such as when a game is being played or not being played.

In general, the gaming machine may allow for “pop-up” windows (also, non-overlapping windows) that may be controlled by in certain locations in a time dependent manner. For instance, when a gaming machine has been idle of a particular amount of time, the gaming machine may allow a pop-up window for an attract feature where the attract feature is provided in the pop-window by an ECI and where the pop-up window blocks a portion of the game interface. The pop-up window for the attract feature may be closed when the gaming machine detects an event that may indicate that a player wishes to play a game, such as when a bill validator or coin acceptor is activated or when a card insert is detected at a card reader. In another example, a “pop-up” window that is controlled by an ECI may be allowed after an event indicating a player no longer wishes to play a game, such as when a player has pressed a cash-out button at this point a pop-up window or non-overlapping window, may appear where a remote host via an ECI provides content in the pop-window or non-overlapping window that may entice a player to continue playing (e.g., promotional credits, free spin, etc.) or to spend their winnings in some manner (redeem their winnings for a prize).

In particular embodiments, an ECI may be utilized to output content to a display portion on the display that is non-contiguous. For instance, the ECI may be permitted to output content to a display portion comprising a rectangular bar across the top of the display and a rectangular bar across the bottom display where the rectangular bar at the top of the display and the rectangular bar across the bottom of the display don't over-lap.

In yet particular embodiment, an ECI may be utilized to output content across a display portion that spans multiple displays. For instance, the ECI may be utilized to display content on all or a portion of a secondary display separate from display 102 and a portion of display 102. Thus, in one example, content may be provided that appears to move from one display to the other. As another example, the separate secondary display may not include a touch sensor while the portion of display 102 does include a touch sensor. Thus, the portion of the display 102 controlled by the ECI may be used to provide input buttons that affect content that is displayed on the secondary display controlled by the ECI when the ECI controls a portion of the touch screen display 102 and all or a portion of the secondary display.

Multiple Remote Hosts

FIG. 7A is a block diagram illustrating an interaction between two hosts, 202 and 204, and a gaming machine 201 for one embodiment of the present invention. Each host controls an ECI on gaming machine 201. Host 202 controls ECI 226 and host 204 controls ECI 228. The hosts, 202 and 204, may control their respective ECIs, 226 and 228, in an independent or a dependent manner with respect to one another. In the independent case, events generated with respect to the execution of one ECI don't affect the execution of the other ECI. In the dependent case, one or both ECIs may generate events that affect one another. In one embodiment of the present invention, two remote hosts, such as 202 and 204, may share access to a single ECI and may alternately or simultaneously provide content for the ECI. Further, as previously described, the ECIs, such as 226 and 228, may directly share information without routing it through their respective hosts.

Each host includes a state manager, 206 and 208, content, 214 and 216, a history manager, 210 and 212, an interface manager, 218 and 220, and a resource negotiator, 222 and 224. The state manager may maintain a state of the ECI on the gaming machine. In the event of a malfunction on a) the gaming machine, b) the host or c) in the network between the host and the gaming machine. The state manager may be designed to store information that enables the remote host, if it chooses to restore an ECI on the gaming machine 201 to a state proximate to the state immediately prior to an occurrence of the malfunction. In one embodiment, the gaming machine maintains its own state via state manager 234 but not the state of any of the ECIs executing on the gaming machine 201. In other embodiments, the gaming machine may maintain some state information regarding the content displayed in the ECI. For example, the gaming machine may capture frames output to its display that include information from an ECI controlling a portion of the display.

The hosts, 202 and 204, may each provide content to ECIs executing simultaneously on a plurality of gaming machines. The content provided on each gaming machine may be different (e.g., the content may be personalized using information regarding the player at each machine or the hosts may be dynamically responding to events generated on each gaming machine and adjusting content accordingly) and the gaming machines served by each host may be different (e.g., host 202 may provide content to gaming machines A, B and C while host 204 is providing content to gaming machines B, C, D). For each gaming machine that the host provides content via an ECI, the hosts, 202 and 204, may maintain a state of the content. The content, as described above, may comprise data and/or instructions provided as application files that are run and/or parsed by the ECI. The application files may include information/data used by the ECI and commands/instructions for utilizing one or more functions of the ECI. For instance, an ECI may be operable to receive command/instructions in regards to utilizing vector graphic capabilities of the ECI. In addition, when vector graphics are applied, the ECI may be operable to apply edge smoothing the vector-based graphics.

In regards to vector graphics, computers may display graphics in two formats: vector and bitmap. Bitmaps are made up of discrete units called pixels. Each pixel contains a single color. When combined, the variations in pixel color create the patterns that make up an image. Bitmaps contain color information for each pixel in an image plus the dimensions for the image, and transmit images pixel by pixel. To change the size of a bitmap image, i.e., to fit into a display region with different dimensions than the original bitmap. The bitmap image has to be regenerated at the desired dimensions or the image has to be stretched, usually with undesirable results.

By comparison, vector graphics store a series of commands/instructions necessary to create an image using lines and curves. The commands, called vectors, dictate attributes of lines and curves such as thickness, direction, color, and position. A processor associated with the master gaming controller may be utilized to process the commands locally to generate a specified vector image. For instance, the master gaming controller may execute an ECI that is operable to parse vector graphic instructions and generate the image specified by the instructions.

Vector graphics allow for fine detail and may be easily be resized without losing definition. An image generated with vector graphics may be modified by changing the attributes of the lines and curves comprising the image. Vector graphics are best for displaying simple shapes with flat areas of color, such as icons, logos, and cartoon-style drawings. Both vector and bitmap graphics may be drawn on request, but vectors may generally use much smaller file sizes and can be drawn much more quickly. When downloaded, bitmaps are transmitted pixel by pixel, so file size and download time are proportional to an image's dimensions. Vector graphics transmit instructions, which are then carried out by your processor, so that file size and rendering speed are determined by the complexity of the instructions, not the size of the graphic. In various embodiments, various graphical techniques and data may be utilized for providing video content to an ECI including vector graphics, bit map images, movies, etc.

The state managers, 206 and 208, may each generate information that is sent to their history manager, 210 and 212, for dispute resolution and auditing purposes. In the event of a dispute, for example, a player may dispute an event that happened three games ago on the gaming machine when ECI 226 and ECI 228 were executing. The gaming machine 201 may include logic that enables the gaming machine to contact each host and request information regarding one or more states of the ECI it supported during the disputed game. The host may send the requested information to the gaming machine for display.

To enable for dispute resolution, the gaming machine 201 and the hosts 202 and 204 may exchange information, such as time stamps, game start time, game finish time, ECI start time, ECI finish time, event occurred at time A, etc., that enable content generated by each device and stored by the history manger to be recalled and correlated to one another. This information may be exchanged while the ECI is executing and then again later when requests for stored information are received by one of the hosts.

As an example of state history management and access, the gaming machine 201 may store a start and stop time for each game, whether one or more ECIs were executed during the game and when at least one ECI is executed during a particular game, information needed to contact the host that provided content for the ECI. Thus, the gaming machine 201 may be able to contact one of the remote host and request ECI states during a time period, which corresponds to a particular game. In response, the host may send the requested information to the gaming machine.

The gaming machine 201 may provide a number of shared resources 240 that may be utilized by an ECI, such as 226. For instance, in one embodiment, the gaming machine 240 may be operable to share a) processing resources from a processor, such as 240, b) memory 244 which may comprise volatile memory, such as RAM or non-volatile memory, such as flash memory or a hard drive, c) one or more displays, such as display A 246 or display B, 248, d) one or more communication interfaces, such as a network communication interface 250 or a wireless interface (not shown) that allows the gaming machine to communicate with wireless devices located proximate to the gaming machine 201, e) audio devices 252, such as speakers, amps and signal codecs for processing sound files, f) input/output devices, such as a touch screen 254 or card reader 256.

Prior to launching the ECI, a negotiation may take place between the gaming machines and one or more remote hosts in regards to the resources that may be utilized by the ECI while it is executed on the gaming machine. In one embodiment, when an ECI, such as 226, is shared or controlled by two or more hosts or where each host controls its own ECI but the ECIs share common resources and/or resource limitations based on the combined usage of resources used by the ECIs controlled by each host, a resource negotiation may take place between the two or more hosts to determine what resources are needed by each host. The host-to-host negotiation may allow the hosts to provide content/instructions to a shared ECI or to each of their ECIs in an integrated manner so that each host has enough resources to display their content/instructions on the shared ECI or each of their respective ECIs.

For example, if a first ECI controlled by a first host utilizes display 246 and a second ECI controlled by a second host utilizes display 246 each host may only need a portion of the display 246 rather than the whole display. If one or both hosts try to utilize the entire display then both hosts may not be able to have content displayed via their ECIs simultaneously. But, if the first and the second host agree to share the display by utilizing only a portion of it via a resource negotiation, then the first and second host may be able to display content via their ECIs on the display 246 at the same time. In general, the gaming machine may be the final arbiter of what resources are assigned to each ECI and the host-host negotiations may take place in the context of negotiations with the gaming machine.

In particular embodiments, the resource negotiators 222 and 224 may communicate with the remote resource manager 230 on the gaming machine 201 or each other to determine what resources are available for the ECI that each remote host controls, such as 226 or 228 or for an ECI which the remote hosts share. The one or more remote hosts may use this information to adjust the content that is sent to the gaming machine for its respective ECI. For instance, display 246 and display 248 may be of different sizes. Thus, at some times, a remote host may be provide access to display 246 and provide content to an ECI formatted to be compatible with the resolution of display 246 while at other times display 246 may not be available and the remote host may provide content formatted to be compatible with the resolution of display 248 (The content provided at different times to the displays 246 and 248 may be the same or different content). Further details of resource management are described with respect to at least FIG. 7B.

In yet another embodiment, the remote hosts, 202 and 204, may compete for access to resources on the gaming machine. For example, remote host 202 may provide one advertising stream/content and remote host 204 may provide another advertising stream/content. The gaming machine may allow only one advertising stream/content at a time. Thus, the gaming machine 201 may initiate negotiations where access to its resources goes to the remote host, which is the highest bidder.

The gaming machine may notify potential hosts when resources become available and solicit bids for the resources from two or more hosts. In one embodiment, the gaming machine 201 while displaying content from one host may receive a bid for resources from another remote host and switch access to the gaming machine from a first remote host, such as 202, to a second remote host, such as 204, after receiving a better bid for resources from the second remote host 202.

In yet another embodiment, the gaming machine 201 may provide information regarding various resource packages with various costs to potential remote hosts. The cost of a resource package may affect the amount of resources and priority of access of resources afforded to a remote host providing an ECI. For instance, access to a larger portion of a display that is shared may cost more than access to a smaller portion of the display. As another example, access to a display where control of the display is not to be switched to another remote host provided ECI or taken over by the gaming machine for a particular time period may cost more than sharing access to the display with another remote host and allowing the gaming machine to intermittently use the display.

The interface managers, 218 and 220, may be responsible for determining what content to send each ECI and sending the content. Further, the interface managers may be designed to respond to events generated on the gaming machine. For example, when interface manager 218 receives information indicating a touch screen has been activated on the gaming machine via the event manger 262, the interface 218 manager may determine whether the touch screen is activated in a display area that it controls and whether content displayed on ECI 226 needs to be adjusted. As another example, when the interface managers, 218 or 220, receive information regarding the resolution of a particular display and visual content is to be displayed, the interface managers, may select content stored on their respective remote host that is closet to a needed resolution, reformat (if needed) the content, generate new content to fit the resolution of the particular display or locate and/or download needed content from another source, such as another remote host.

In particular embodiments, an ECI and/or remote host may not be granted access to all of the features of the shared resources. For example, when the card reader is operable to read/write data to a card, such as a smart card. The ECI may be allowed to receive data read from a card but not write data to the card. In one embodiment, during the negotiation phase, the gaming machine may provide a) a list of available shared resources, b) features of the shared resources that may be controlled by the remote host directly and/or via an ECI including commands and data formats that allow the features to be utilized, c) under what conditions the features may be utilized, etc.

In one embodiment, the data formats, commands and/or instructions that an ECI or remote host may utilize may be incorporated in a communication protocol that is utilized by both the ECI and/or remote host and gaming machine (or gaming device). In particular embodiment, the commands/instructions that the ECI and the remote host may communicate to the gaming machine, such as to control a device, may be high-level commands that are translated by the gaming machine to low-level instructions that are used to actually perform the operation that is requested. For instance, to spin a bonus wheel coupled to the gaming machine, a remote host and/or ECI may send a “spin wheel” command to the gaming machine. The gaming machine may translate the command to a number of low-level instructions that a stepper motor coupled to the gaming machine to be controlled. In another embodiment, the ECI and/or remote host may be operable to provide low-level instructions that allow a device to be directly controlled. For instance, the ECI and/or remote host may be able to send the low-level instructions for controlling the stepper motor directly to the bonus wheel without needing the gaming machine to translate.

In a particular embodiment, the communications between the gaming machine and the remote host may be separated into two parts. The first part of the communications may include information regarding gaming machine transactions, such as money handling, metering, game outcomes, random number generation, player identification information. In general, the first part of the communications may include information that is generated as a result of game play from a primary game of chance executed on the gaming machine. In one embodiment, the gaming machine transaction information may be communicated using the G2S protocol approved by the Gaming Standards Association (Fremont, Calif.). The second part of the communications between the gaming machine and the remote host may enable the communications between the remote host and the ECI, such as commands, instructions and/or data sent between the remote host and the ECI, which may include content for the ECI to output.

One advantage separating the communications in this manner is that the ECI may be isolated from game play information. When the ECI is isolated from game play information, it may result in a more secure system. The higher level of security is based on the assumption that if a process executing on the gaming machine is unaware of game play information, such as the state of a game, it will more difficult for the process to affect the game in unacceptable manner. It is noted that although the ECI may not be aware of game play information, as described in the previous paragraph, the remote host may be aware of game play information.

The game play information described in the previous paragraph may be related to information generated as a result of play of a primary game of chance generated on the gaming machine. Further, in some embodiments, the ECI itself may provide the play of games separate from the primary game. Nevertheless, the ECI may not be aware that is providing the play of a game and may be still unaware of any game play information that is generated. From the perspective of the ECI, it is simply outputting content utilizing commands, instructions and data provided by a remote host where the ECI does not distinguish between game related content and non-game related content.

In particular embodiments, the ECI may be operable to process input generated as a result of the play of the game provided by the ECI but may not be operable to distinguish this input from other types of input, i.e., it may not be configured to determine the function associated with the input. For instance, the ECI may be instructed by the remote host to generate a bet button on a touch screen display for a game output utilizing the ECI. The ECI may be operable to receive input from the touch screen and determine that a particular button has been pressed. The ECI may forward this information to the remote host and the remote host may determine that this button corresponds to a bet button. The ECI may be unaware the button for a bet has been pressed or activated, i.e., it is unaware of the function of the button.

In particular embodiments, when an ECI and/or remote host is access or control is prohibited for one or more resources, such as utilizing a peripheral device or utilizing one of the features of the peripheral device coupled to the gaming machine, and the ECI and/or remote host generates an instruction that tries to utilize or control the resource, then the gaming machine may respond in various manners. For example, in one embodiment, if the device or device feature the ECI and/or remote host is trying to access or control is not critical, then the gaming machine may simply ignore the command or instruction and possibly notify the device that it is trying to perform a function that is not available to it. For instance, the ECI and/or remote host may send instructions to a gaming machine to flash lights when this function is not available to it, and the gaming machine may simply ignore the instructions.

In another embodiment, the ECI and/or remote host may try to access or control a critical device in a manner that is prohibited. For instance, ECI or remote host could try to send a command to a printer to print a cashless ticket of a particular value, which is not allowed. In some possible responses, the gaming machine may 1) log the event, 2) terminate the connection with the ECI, 3) enter a tilt state or 4) combinations thereof. Some details of tilt handling that may be utilized with various embodiments are described in U.S. Pat. No. 6,890,259, entitled, “Modular Tilt Handling,” which is incorporated by reference and for all purposes.

In particular embodiments, the available resources that may be utilized by a remote host as part of an ECI may vary from gaming device to gaming device. For example, a casino-type gaming machine with random number generation capability may have more capabilities that may be utilized in an ECI than a portable hand-held device. Further, in other embodiments, the capabilities of a gaming device, such as gaming machine 201, that may be offered to a remote host for utilization may vary depending on the remote host. For example, some remote hosts may be more trusted than other remote hosts and thus may be afforded greater access to devices on the gaming machine than other remote hosts.

During operation of an ECI, the gaming machine may check the resources utilized by an ECI to determine whether the resources utilized by the ECI are in compliance with limits established for the ECI, such as during the negotiation phase. The gaming machine 201 may utilize its local resource management 238 including the partition manager 256, the device scheduler 258 and the resource metering 260 on the gaming machine 201 to check the resource utilization of one or more ECIs individually or a group of ECIs in combination against resource allocations for each individual ECI or the group of ECIs. When resource allocation for an ECI is exceeded, a number of remedial actions may be taken. For instance, when CPU resources are exceeded, the ECI may be denied further CPU cycles and the display characteristics of the ECI may slow down and become jerky. Further, the gaming machine may notify the ECI that it has it exceeded it resource requirements. As another example, when resources are exceeded, the gaming machine may terminate a session with the remote host and stop execution of the ECI on the gaming machine. The execution of the ECI may be stopped permanently or may be stopped temporarily until more resources become available on the gaming or until the remote host adjusts the content of the ECI.

As examples, an ECI may exceed its allocated resources because the gaming machine downwardly adjusted the resources available to the ECI after the start of an ECI session or because the remote host didn't correctly estimate an amount of resources it needed. In response to learning it is exceeding resources it has been allocated on the gaming machine, the remote host, such as 202 or 204, may adjust their content to consume less resources on the gaming machine. In particular embodiments, the remote hosts, such as 202 and 204, may be operable to dynamically adjust the content that is sent to the gaming machine for utilization by an ECI after a session has been initiated (at the start of the session an initial resource allocation may be specified) 1) to satisfy changing resource allocations on the gaming machine, which may change, and thus, to prevent it from exceeding its resource allocation.

Since the manner in which an ECI and/or remote host may be allowed to access or utilize a gaming machine may vary, such as from one remote host to another, from one time to another and different gaming machine may have different capabilities (e.g., a gaming machine may have different capabilities than a portable), the gaming machine may include logic for checking instructions and/or data received from an ECI and/or remote host to comply with their access privileges. For example for illustrative purposes only as a communication protocol doesn't have to be utilized, when the instructions and/or data are codified in a communication protocol, the gaming machine may first check to see whether the instructions and/or data is a recognized part of the protocol. Then, even if the instructions and/or data is part of the protocol, the gaming machine may not offer the capability requested, thus compatibility of instructions and/or data with the gaming machine capabilities may be checked (At the negotiation phase, the instructions and/or data that the gaming machine is capable of utilizing, which may be a subset of the instructions and/or data that may be communicated as part of the communication protocol may be established.) Then, the instructions and/or data may be checked against the access privileges for the particular ECI and/or remote host. For each remote host and its associated ECI, information regarding resource access privileges may be stored (The information may have been generated at the negotiation phase or at some other time). The privilege and/or error checking may be performed by the privilege checking logic 274 in the local resource management 238.

### Resource Allocation

FIG. 7B is a block diagram showing hardware and software components and their interactions on a gaming machine for embodiments of the present invention. In embodiments of the present invention, the operating system may maintain “resource partitions.” A resource partition may be logical abstraction implemented in the operating system logic that enables the operating system to monitor and limit the resources used by all of the process or process threads executing in each resource partition. At any given time, a resource partition may include one or more member processes or member process threads. For example, in one embodiment of the present invention, a QNX operating system (Ottawa, Canada) may be employed. With QNX, each thread of execution may be individually assigned to a different resource partition. Thus, one process may have several threads each running in different partitions. In general, the operating system may be a POSIX compliant operating system, such as Unix and Linux variants, Windows™ NT, 2000, XP, Vista, etc.

Resource partitioning is one example or aspect of virtualization. Virtualization is the process of presenting a logical grouping or subset of computing resources so that they can be accessed in ways that give benefits over the original configuration. In particular, virtualization may provide techniques for hiding the physical characteristics of computing resources from the way in which other systems, applications, or end users interact with those resources. These techniques may include making a single physical resource (such as a server, an operating system, an application, or storage device) appear to function as multiple logical resources; or it can include making multiple physical resources (such as storage devices or servers) appear as a single logical resource. Virtualization may refer to the abstraction of resources in many different aspects of computing and may include virtual machines and systems management software. Thus, the examples of resource partitioning and other virtualization examples are provided for illustrative purposes only and are not intended to limit the invention to virtualizations providing only resource partitioning or the other examples of virtualization mentioned herein.

As noted above, threads may be assigned to different partitions in some embodiments of the present invention. A thread may be short for a thread of execution. Threads are a way for a program to split itself into two or more simultaneously (or pseudo-simultaneously) running tasks. Threads and processes differ from one operating system to another, but in general, the way that a thread is created and shares its resources may be different from the way a process does.

Multiple threads may be executed in parallel on many computer systems. This multithreading may be provided by time slicing, where a single processor switches between different threads, in which case the processing is not literally simultaneous, for the single processor is only really doing one thing at a time. This switching can happen so fast as to give the illusion of simultaneity to an end user. For instance, a typical computing device may contain only one processor, but multiple programs can be run at once, such as an ECI for player tracking alongside an a game program; though the user experiences these things as simultaneous, in truth, the processor may be quickly switching back and forth between these separate threads. On a multiprocessor system, threading can be achieved via multiprocessing, wherein different threads can run literally simultaneously on different processors.

In embodiments of the present invention, multiprocessor systems with multiple CPUs may be used in conjunction with multiprocessing. For example, an ECI process or ECI thread may be executed on one or more CPUs while a game is executed on one or more different CPUs. In a particular embodiment, in a multiprocessor system, CPU accessibility may be limited according to the application. For instance, ECI's may be only executed on certain processors and games on other processors. The ECI's may be prevented from utilizing processors dedicated to executing games or other applications.

Threads are distinguished from traditional multi-tasking operating system processes in that processes are typically independent, carry considerable state information, have separate address spaces, and interact only through system-provided inter-process communication mechanisms. Multiple threads, on the other hand, typically share the state information of a single process, and share memory and other resources directly. Although, as noted above, threads of the same process may be assigned to different resource partitions. Context switching between threads in the same process may be typically faster than context switching between processes.

In general, the term, “process” refers to a manipulation of data on a device, such as a computer. The data may be “processed” in a number of manners, such as by using logical instructions instantiated in hardware, by executing programming logic using a processor, or combinations thereof. Thus, a “process” for the purposes of this specification may describe one or more logical components instantiated as hardware, software or combinations thereof that may be utilized to allow data to be manipulated in some manner. Therefore, the terms “process” and “process thread” as described are provided for the purposes of clarity only and are not meant to be limiting.

Four resource partitions, 360, 366, 368 and 370 are illustrated in FIG. 7B. An operating system resource partition 360 that includes processes (or process threads) executed by the operating system. A game resource partition 366 from which game processes (or process threads) are executed. An ECI resource partition 382 from which a first ECI process 382 (or ECI process thread) may be executed and an ECI resource partition 368 from which a second ECI process 380 (or ECI process thread) may be executed. As noted above, resource partitioning may be performed at the process level, the process thread level or combinations thereof.

In one embodiment, resource partition definitions 308, such as resources allocated to each resource partition and processes that are enabled to execute in each partition (e.g. partition assignments 310) may be stored in the secure memory 326. Data stored in the secure memory may have been authenticated using the authentication components 304 stored on the Boot ROM 302. When a process is launched by the operating system, it may check to see which resource partition to assign the process using the partition assignments 310, which may include a list of processes that may be executed in each partition. In one embodiment, some processes may be assigned to more than one resource partition. Thus, when the resources associated with a first resource partition are being fully utilized, the process may be executed from a second resource partition with available resources.

In another embodiment, the partition assignment information may be stored with each executable image, such as images, 316, 318 and 320. When a process or process thread is launched, the operating system may determine which partition to assign the process or the process thread (In general, each process will have at least one process thread). With this method, new executable images may be downloaded to the gaming machine from a remote device that are not listed in the partition assignments 310 and still be assigned to a resource partition.

In a particular embodiment, the operating system may only allow one ECI process or ECI process thread to execute in a partition at one time. In other embodiments, a plurality of ECI processes may be executed from a single partition at one time. When only a single ECI process is allowed to execute from a partition at one time, the amount of resources available to the ECI process occupying the partition may be more predictable. This type of architecture may be valuable when ECI's are provided from two or more different hosts simultaneously where each remote host doesn't necessarily know the resource requirements utilized by an ECI from another remote host. When two or more ECIs are allowed to occupy a single partition and execute simultaneously, the resources provide to each ECI, respectively, may be more vary more if each respective ECI is competing for a limited amount of resources.

The resource competition may be become more acute when the resources needed by two or more ECIs are near or greater than one or more resources (e.g., CPU cycles or memory) provided in a partition. In some embodiments, the gaming machine may prioritize resource utilization by each ECI process. For instance, an execution priority may be assigned to each ECI process executing in a resource partition such that based on the priority one ECI process is favored over another ECI process when they are both competing for resources.

The priority assigned to each ECI process may be based on another factors. A priority to resources may be assigned to an ECI process based upon its function. For instance, an ECI for providing a bonus interface may be given a higher priority to resources than an ECI for providing advertising. In another embodiment, a priority may be assigned to an ECI process in accordance with a price paid to allow the ECI process and its content to be presented on the gaming device. In general, prioritization for utilizing resources is another way of providing virtualization on a gaming device.

Resources that may be monitored and limited for each partition include but are not limited CPU usage, memory usage, such as RAM usage, NV-RAM usage, disk memory usage, etc., GPU (graphics processing usage), network bandwidth, sound card usage and access to gaming devices, such as displays, audio devices, card readers, bill validators. Resources that may be monitored on the gaming machine 300 include the executable space 338, the processing devices 348, the gaming devices 358 and the secure memory 326. The local resource metering process 238 may monitor resource usage for each partition. In FIG. 7B, the local resource metering process 238 is shown monitoring, device A, device B, network bandwidth usage, processor usage of processors, 340 and 342, power usage, and memory usage.

The local resource metering process 238 may report information to the resource partition manager 256. In particular embodiments, based upon limits placed on each resource partition, the resource partition manager 256 may prevent new processes from executing in a particular resource partition or may even terminate certain processes to free up resources processes executing in other partitions. For example, if the output of the game on the gaming machine 300 is less than optimal because of the resources utilized by the ECI 380 or ECI 382, the gaming machine may suspend execution or terminate execution of one or both of the ECI 380 or ECI 382.

In particular embodiments of the present invention, prior to enabling a remote host to control an ECI on the gaming machine 300 and based on its resource partitioning system, the gaming machine 300 may notify the remote host of information regarding the resources it may have available to use while the ECI it wishes to control is executing on the gaming machine 300. In one embodiment, the remote resource manager 230 may report this information to the remote host. In another embodiment, the gaming machine may broadcast its available resources to a plurality of remote hosts that may control an ECI on the gaming machine 300. These messages may be broadcast at regular intervals and change depending on a current resource utilization on the gaming machine.

The resource information may include information regarding an upper limit of resources that may be available (e.g., a maximum of 10% CPU usage, 100 MB of RAM), a lower limit of resources that may be available (e.g., a minimum of 5% CPU usage, 50 MB of RAM, no audio capabilities), a prediction of a range of resources that may be available over time (e.g., at least 400×300 pixel window with periodic access to a 1600×1200 pixel window and at least 4 channels of 32 channel sound card with periodic access to all channels), a prediction of platform performance based on the available resources (e.g., an output frame rate of 25 frames per second at 60 Hz screen refresh rate using 16 bits of color). An upper and lower limit of resources may be provided because the resources available on the gaming machine may change with time while an ECI is executing.

Additional partitioning information may include a display mode, such as a translucent overlay of the game screen or a display location (e.g., left third of the display screen). Further, information sent to the remote host may include game theme, graphics and sound information currently executing on the gaming machine 300. The remote host may utilize this information to customize content for an ECI executing on the gaming machine 300 that is thematically consistent with a game executing on the gaming machine 300.

In addition, the gaming machine may send file information to the remote host information regarding files, such as application files executed by an ECI, stored in the resource partitions. The files may have been previously downloaded from the remote host or a different remote host at an earlier. One or more files or information/data/commands within the one or more files may be of use to the remote host and thus, the remote host may structure a download based on the file information. For instance, the remote host may download files/data/content that is only needed in addition to the files/data/content already stored on the gaming machine.

In response to the resource information it receives from the gaming machine, the remote host may determine whether the resources are adequate to output the content it wishes to present on the gaming machine via the ECI. In some embodiments, the remote host may adjust the content to output via the ECI to account for the available resources. For instance, when resources are limited, pre-rendered images, 2-D graphics or vector-based graphics may be used instead of dynamically rendered 3-D graphics. As another example, if network traffic is high, such that the network bandwidth is limited, the remote host may reduce the amount of data sent to gaming machine. Details of graphical related apparatus and methods that may be utilized in embodiments of the present invention are described with respect to U.S. Pat. No. 6,887,157, filed Aug. 9, 2001, by LeMay, et al., and entitled, “Virtual Cameras and 3-D gaming environments in a gaming machine,” which is incorporated herein and for all purposes.

In a particular embodiment, the remote host may request additional resources than the gaming machine 300 has said are available. In response, the gaming machine 300 may temporarily create a resource partition, such as 370 or 368, or another type of virtualization (e.g., a virtual machine) that enables the remote host to access the additional requested resources while the ECI is executed. In other embodiments, the resources available on the gaming machine may not be suitable for the content that the remote host has available and the remote host may decide not to control an ECI, such as 382 or 380.

One advantage of using a virtualization, such as resource partitions, may be that a remote host in control of an ECI on a gaming machine may be enabled to control of resources while guaranteeing adequate game performance. A gaming machine operator always wants a game player to be presented with a quality game experience including presentations with desirable graphics and sounds. If providing access to gaming machine resources via an ECI results in an excessive degradation of the game experience (e.g., the graphics become jagged or jumpy), then sharing of gaming resources using an ECI would not be desirable. New gaming machine are becoming increasingly powerful in their capabilities. The use of ECIs in combination with resource partitioning enables under utilized gaming machine resources to be used in an effective manner while insuring that a quality game experience is always is provided to a game player.

Another advantage of using a virtualization, such as resource partitions, may be that testing requirements related to the development of game software and ECI software may be simplified. One method of ensuring a quality game experience is maintained on a gaming device while a game process for generating a game is executing on the gaming device while one or more ECI processes are executing is to extensively test the one or more ECI processes and game process under a variety of conditions. Testing every possible ECI process in combination with one or more possible ECI process in conjunction with every different game variation quickly becomes very unattractive in terms of both cost and time.

Using virtualization, where the maximum resources allowed to be utilized by one or more ECI processes are prevented from exceeding a set limit, the gaming software for generating a game on the gaming machine may be tested where a maximum resource utilization allowed for the one or more ECI processes is simulated while the game is being executed. The game may be tested under a variety of operational conditions, such as when it is using a maximum number of CPU cycles or graphic processor cycles, to ensure that the generated game is adequate at the maximum resource utilization condition allowed for the one or more ECI processes. After the testing, it may be concluded that the game performance will be adequate for any combination of one or more ECI processes using up to the maximum allowable resources for the ECIs. Thus, new ECI processes may be developed after the game is released without having to test the performance of the game in combination with each new ECI.

In addition, each ECI process may be tested to determine whether they perform adequately under various resource conditions up to the maximum resources allowed for a single ECI on a gaming device. This process may allow ECI developers to develop and test ECIs and associated content that are appropriate for different resource ranges up to the maximum allowed resources without needing to test them in combination with each possible game. Further, the developer may develop multiple ECIs and associated content to perform a particular function using different amount of resources with the knowledge that each ECI will perform adequately after testing. For example, a first ECI may use vector graphics to provide an animation, which requires less memory and allows for a faster download time, as compared to a second ECI that uses pre-rendered bitmaps to provide the animation where the function of the first and second ECI are the same.

As described above, in regards to virtualization, the present invention is not limited to resource partitioning. Other examples of virtualization that may be employed in embodiments of the present invention are described as follows. Via Intel's Virtualization Technology (or the corresponding AMD technology), these microprocessor vendors have introduced features in their micro-architectures that may improve the processor's ability to run multiple operating systems and applications as independent virtual machines. Using this virtualization technology, one computer system can appear to be multiple “virtual” systems. Thus, in various embodiments, a gaming environment utilizing virtual gaming machines where the operating systems may vary from virtual gaming machine to virtual gaming machine may be employed. In a particular embodiment, a virtual gaming machine may use a core of a multi-core processor.

A virtual gaming machine may use a virtual machine monitor (VMM) A virtual machine monitor may be a host program that allows a single computer to support multiple, identical execution environments. All the users may see their systems as self-contained computers isolated from other users, even though every user is served by the same machine. In this context, a virtual machine may be an operating system (OS) that may be managed by an underlying control program.

Low interrupt latency, direct access to specialized I/O, and the assurance that a VMM won't “time slice away” the determinism and priority of real-time tasks may be important for a real-time virtual gaming machine used in a gaming environment. In one embodiment of the present invention, the combination of multi-core CPUs and Intel VT or a related technology may be used to build a real-time hypervisor based on dynamic virtualization.

A real-time hypervisor may be a VMM that uses hardware virtualization technology to isolate and simultaneously host general-purpose operating systems and real-time operating systems. Unlike a static virtualization, the dynamic virtualization implemented by a real-time hypervisor may use an “early start” technique, to take control of the hardware platform. Thus, operating systems may only be allowed to “boot” only after the real-time hypervisor has constructed a virtual machine for them. The guest operating system may be associated with a particular game provided by a software provider. Thus, in the present invention, a gaming platform may support games provided by multiple software vendors where different games may be compatible with different operating systems.

In the processors that include Intel VT an overarching operating-mode has been added, called VMX root, where a hypervisor executes with final control of the CPU hardware. A hypervisor that uses Intel VT may intercept key supervisor-mode operations executed by any software operating outside of VMX root without requiring a prior knowledge of the guest OS binaries or internals. Using this Intel VT hardware assist for virtualization, one may build a hypervisor VMM that hosts protected-mode operating systems executing in ring 0 without giving up control of key CPU resources. Also, Intel VT provides a way for the VMM to implement virtual interrupts.

In the present invention, static and dynamic virtualization may be used. Nevertheless, two advantages to building a multi-OS real-time system by using dynamic virtualization rather than static virtualization may be: first, a wide range of operating systems, both general-purpose and real-time, may be supported and, second, the boot sequence for each guest OS may be under the control of the hypervisor. The second advantage means it may possible, in embodiments of the present invention, to restart one guest OS while other guest operating systems continue to run without interruption.

TenAsys provides an example of a hypervisor that may be used in embodiments of the present invention. The hypervisor may be capable of supporting the demands of a Real-time operating system (RTOS) while simultaneously hosting a general-purpose operating system (GPOS), like Windows or Linux. The hypervisor may enhance real-time application responsiveness and reliability in a “multi-OS, single-platform” environment, by providing control over interrupt latency and partitioning of I/O resources between multiple guest operating systems.

In various embodiments, the hypervisor may be used to distinguish between resources that may be multiplexed by the VMM and those that are exclusive to a virtual machine. For example, When user interface I/O is not associated with time-critical events, input devices like the keyboard, mouse, console, disk, and an enterprise Ethernet interface may be multiplexed and shared between all virtual machines. However, hardware that is specific to a real-time control application, such as a video capture card, fieldbus interface, or an Ethernet NIC designated for communication with real-time I/O devices, may not be multiplexed between virtual machines. Using the hypervisor, specialized real-time I/O may be dedicated to its real-time virtual machine, so the RTOS and application using that I/O can maintain real-time determinism and control.

In one embodiment of a VMM some or all of the memory in each virtual machine may be swapped to disk, in order to more efficiently allocate limited physical RAM among multiple virtual machines. In another embodiment, a real-time hypervisor may be used to guarantee that each real-time virtual machine is locked into physical RAM, and is never swapped to disk. This approach may be used to insure that every real-time event is serviced consistently, with deterministic timing. In yet another embodiment, the hypervisor may used to dedicate a core in a multi-core processor to a virtual machine, such as a virtual gaming machine.

### Gaming Machine

FIG. 8 shows a perspective view of a gaming machine 2 in accordance with a specific embodiment of the present invention. The gaming devices and gaming functions described with respect to at least FIG. 8 may be incorporated as components of the ECI's and media display devices described above with respect to at least FIGS. 1 thru 7 and 9. Further, the gaming devices may be operated in accordance with instructions received from a remote host in communication with the gaming machine. In some instance, a host-controlled process executed on the gaming machine may share a gaming device with a process controlled by the master gaming controller 46 on the gaming machine.

As illustrated in the example of FIG. 8, machine 2 includes a main cabinet 4, which generally surrounds the machine interior and is viewable by users. The main cabinet includes a main door 8 on the front of the machine, which opens to provide access to the interior of the machine.

In one embodiment, attached to the main door is at least one payment acceptor 28 and a bill validator 30, and a coin tray 38. In one embodiment, the payment acceptor may include a coin slot and a payment, note or bill acceptor, where the player inserts money, coins or tokens. The player can place coins in the coin slot or paper money, a ticket or voucher into the payment, note or bill acceptor. In other embodiments, devices such as readers or validators for credit cards, debit cards or credit slips may accept payment. In one embodiment, a player may insert an identification card into a card reader of the gaming machine. In one embodiment, the identification card is a smart card having a programmed microchip or a magnetic strip coded with a player's identification, credit totals (or related data) and other relevant information. In another embodiment, a player may carry a portable device, such as a cell phone, a radio frequency identification tag or any other suitable wireless device, which communicates a player's identification, credit totals (or related data) and other relevant information to the gaming machine. In one embodiment, money may be transferred to a gaming machine through electronic funds transfer. When a player funds the gaming machine, the master gaming controller 46 or another logic device coupled to the gaming machine determines the amount of funds entered and displays the corresponding amount on the credit or other suitable display as described above.

In one embodiment attached to the main door are a plurality of player-input switches or buttons 32. The input switches can include any suitable devices which enables the player to produce an input signal which is received by the processor. In one embodiment, after appropriate funding of the gaming machine, the input switch is a game activation device, such as a pull arm or a play button which is used by the player to start any primary game or sequence of events in the gaming machine. The play button can be any suitable play activator such as a bet one button, a max bet button or a repeat the bet button. In one embodiment, upon appropriate funding, the gaming machine may begin the game play automatically. In another embodiment, upon the player engaging one of the play buttons, the gaming machine may automatically activate game play.

In one embodiment, one input switch is a bet one button. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one.

In another embodiment, one input switch is a bet max button (not shown), which enables the player to bet the maximum wager permitted for a game of the gaming machine.

In one embodiment, one input switch is a cash-out button. The player may push the cash-out button and cash out to receive a cash payment or other suitable form of payment corresponding to the number of remaining credits. In one embodiment, when the player cashes out, the player may receive the coins or tokens in a coin payout tray. In one embodiment, when the player cashes out, the player may receive other payout mechanisms such as tickets or credit slips redeemable by a cashier (or other suitable redemption system) or funding to the player's electronically recordable identification card. Details of ticketing or voucher system that may be utilized with the present invention are described in co-pending U.S. patent application Ser. No. 10/406,911, filed Apr. 2, 2003, by Rowe, et al., and entitled, “Cashless Transaction Clearinghouse,” which is incorporated herein by reference and for all purposes.

In one embodiment, one input switch is a touch-screen coupled with a touch-screen controller, or some other touch-sensitive display overlay to enable for player interaction with the images on the display. The touch-screen and the touch-screen controller may be connected to a video controller. A player may make decisions and input signals into the gaming machine by touching the touch-screen at the appropriate places. One such input switch is a touch-screen button panel.

In one embodiment, the gaming machine may further include a plurality of communication ports for enabling communication of the gaming machine processor with external peripherals, such as external video sources, expansion buses, game or other displays, an SCSI port or a key pad.

As seen in FIG. 8, viewable through the main door is a video display monitor 34 and an information panel 36. The display monitor 34 will typically be a cathode ray tube, high resolution flat-panel LCD, SED based-display, plasma display, a television display, a display based on light emitting diodes (LED), a display based on a plurality of organic light-emitting diodes (OLEDs), a display based on polymer light-emitting diodes (PLEDs), a display including a projected and/or reflected image or any other suitable electronic device or display. The information panel 36 or belly-glass 40 may be a static back-lit, silk screened glass panel with lettering to indicate general game information including, for example, a game denomination (e.g. $0.25 or $1) or a dynamic display, such as an LCD, an OLED or E-INK display. In another embodiment, at least one display device may be a mobile display device, such as a PDA or tablet PC, that enables play of at least a portion of the primary or secondary game at a location remote from the gaming machine. The display devices may be of any suitable size and configuration, such as a square, a rectangle or an elongated rectangle.

The display devices of the gaming machine are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, and the like. In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one or a plurality of game or other suitable images, symbols or indicia. In another embodiment, the display device may include an electromechanical device adjacent to a video display, such as a video display positioned in front of a mechanical reel. In another embodiment, the display device may include dual layered video displays which co-act to generate one or more images.

The bill validator 30, player-input switches 32, video display monitor 34, and information panel are gaming devices that may be used to play a game on the game machine 2. Also, these devices may be utilized as part of an ECI provided on the gaming machine. According to a specific embodiment, the devices may be controlled by code executed by a master gaming controller 46 housed inside the main cabinet 4 of the machine 2. The master gaming controller may include one or more processors including general purpose and specialized processors, such as graphics cards, and one or more memory devices including volatile and non-volatile memory. The master gaming controller 46 may periodically configure and/or authenticate the code executed on the gaming machine.

In one embodiment, the gaming machine may include a sound generating device coupled to one or more sounds cards. In one embodiment, the sound generating device includes at least one and preferably a plurality of speakers or other sound generating hardware and/or software for generating sounds, such as playing music for the primary and/or secondary game or for other modes of the gaming machine, such as an attract mode. In one embodiment, the gaming machine provides dynamic sounds coupled with attractive multimedia images displayed on one or more of the display devices to provide an audio-visual representation or to otherwise display full-motion video with sound to attract players to the gaming machine. During idle periods, the gaming machine may display a sequence of audio and/or visual attraction messages to attract potential players to the gaming machine. The videos may also be customized for or to provide any appropriate information.

In one embodiment, the gaming machine may include a sensor, such as a camera that is selectively positioned to acquire an image of a player actively using the gaming machine and/or the surrounding area of the gaming machine. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol or indicia.

In another embodiment, the gaming devices on the gaming machine may be controlled by code executed by the master gaming controller 46 (or another logic device coupled to or in communication with the gaming machine, such as a player tracking controller) in conjunction with code executed by a remote logic device in communication with the master gaming controller 46. The master gaming controller 46 may execute ECI processes that enable content generated and managed on a remote host to be output on the gaming machine. The gaming machine may receive and send events to a remote host that may affect the content output on an instantiation of a particular ECI. The master gaming controller 46 may be configured to limit the resources that can be utilized by the ECI processes executing on the gaming machine at any given time and may constantly monitor resources utilized by the ECI processes to ensure that gaming experience on the gaming machine is optimal.

### Gaming System Components

FIG. 9 shows a block diagram illustrating components of a gaming system 900 which may be used for implementing various aspects of the present invention. In FIG. 9, the components of a gaming system 900 for providing game software licensing and downloads are described functionally. The described functions may be instantiated in hardware, firmware and/or software and executed on a suitable device. In the system 900, there may be many instances of the same function, such as multiple game play interfaces 911. Nevertheless, in FIG. 9, only one instance of each function is shown. The functions of the components may be combined. For example, a single device may comprise the game play interface 911 and include trusted memory devices or sources 909. The described components and their functions may be incorporated various embodiments of the servers and clients described with respect to at least FIG. 1-8.

The gaming system 900 may receive inputs from different groups/entities and output various services and or information to these groups/entities. For example, game players 925 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 900, receive revenue for the use of their software and compensate the gaming machine operators. The gaming regulators 930 may provide rules and regulations that must be applied to the gaming system and may receive reports and other information confirming that rules are being obeyed.

In the following paragraphs, details of each component and some of the interactions between the components are described with respect to FIG. 9. The game software license host 901 may be a server connected to a number of remote gaming devices that provides licensing services to the remote gaming devices. For example, in other embodiments, the license host 901 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 915 may track the usage of game software on a plurality of devices in communication with the host. The game usage-tracking host 915 may be in communication with a plurality of game play hosts and gaming machines. From the game play hosts and gaming machines, the game usage tracking host 915 may receive updates of an amount that each game available for play on the devices has been played and on amount that has been wagered per game. This information may be stored in a database and used for billing according to methods described in a utility based licensing agreement.

The game software host 902 may provide game software downloads, such as downloads of game software or game firmware, to various devious in the game system 900. For example, when the software to generate the game is not available on the game play interface 911, the game software host 902 may download software to generate a selected game of chance played on the game play interface. Further, the game software host 902 may download new game content to a plurality of gaming machines via a request from a gaming machine operator.

In one embodiment, the game software host 902 may also be a game software configuration-tracking host 913. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with the present invention are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 903 may be a host server connected to a plurality of remote clients that generates games of chance that are displayed on a plurality of remote game play interfaces 911. For example, the game play host device 903 may be a server that provides central determination for a bingo game play played on a plurality of connected game play interfaces 911. As another example, the game play host device 903 may generate games of chance, such as slot games or video card games, for display on a remote client. A game player using the remote client may be able to select from a number of games that are provided on the client by the host device 903. The game play host device 903 may receive game software management services, such as receiving downloads of new game software, from the game software host 902 and may receive game software licensing services, such as the granting or renewing of software licenses for software executed on the device 903, from the game license host 901.

In particular embodiments, the game play interfaces or other gaming devices in the gaming system 900 may be portable devices, such as electronic tokens, cell phones, smart cards, tablet PC's and PDA's. The portable devices may support wireless communications and thus, may be referred to as wireless mobile devices. The network hardware architecture 916 may be enabled to support communications between wireless mobile devices and other gaming devices in gaming system. In one embodiment, the wireless mobile devices may be used to play games of chance.

The gaming system 900 may use a number of trusted information sources. Trusted information sources 904 may be devices, such as servers, that provide information used to authenticate/activate other pieces of information. CRC values used to authenticate software, license tokens used to enable the use of software or product activation codes used to activate to software are examples of trusted information that might be provided from a trusted information source 904. Trusted information sources may be a memory device, such as an EPROM, that includes trusted information used to authenticate other information. For example, a game play interface 911 may store a private encryption key in a trusted memory device that is used in a private key-public key encryption scheme to authenticate information from another gaming device.

When a trusted information source 904 is in communication with a remote device via a network, the remote device will employ a verification scheme to verify the identity of the trusted information source. For example, the trusted information source and the remote device may exchange information using public and private encryption keys to verify each other's identities.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 900 of the present invention may include devices 906 that provide authorization to download software from a first device to a second device and devices 907 that provide activation codes or information that enable downloaded software to be activated. The devices, 906 and 907, may be remote servers and may also be trusted information sources. One example of a method of providing product activation codes that may be used with the present invention is describes in previously incorporated U.S. Pat. No. 6,264,561.

A device 906 that monitors a plurality of gaming devices to determine adherence of the devices to gaming jurisdictional rules 908 may be included in the system 900. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 900 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In the present invention, the devices may be connected by a network 916 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to remain viable. Thus, in the present inventions, network efficient devices 910 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in the present invention may provide game software and game licensing related auditing, billing and reconciliation reports to server 912. For example, a software licensing billing server may generate a bill for a gaming device operator based upon a usage of games over a time period on the gaming devices owned by the operator. In another example, a software auditing server may provide reports on game software downloads to various gaming devices in the gaming system 900 and current configurations of the game software on these gaming devices.

At particular time intervals, the software auditing server 912 may also request software configurations from a number of gaming devices in the gaming system. The server may then reconcile the software configuration on each gaming device. In one embodiment, the software auditing server 912 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 9. Many of the interactions are coupled. For example, methods used for game licensing may affect methods used for game downloading and vice versa. For the purposes of explanation, details of a few possible interactions between the components of the system 900 relating to software licensing and software downloads have been described. The descriptions are selected to illustrate particular interactions in the game system 900. These descriptions are provided for the purposes of explanation only and are not intended to limit the scope of the present invention.

Although the foregoing present invention has been described in detail by way of illustration and example for purposes of clarity and understanding, it will be recognized that the above described present invention may be embodied in numerous other specific variations and embodiments without departing from the spirit or essential characteristics of the present invention. Certain changes and modifications may be practiced, and it is understood that the present invention is not to be limited by the foregoing details, but rather is to be defined by the scope of the appended claims.

The invention is claimed as follows:

1. A gaming machine comprising:
a master gaming controller, comprising a first processor and a first memory, designed or configured to control a wager-based game played on the gaming machine, communicatively coupled to a first interface board via a first communication path and a second interface board via a second communication path;
a display coupled to the master gaming controller designed or configured to output an outcome to the wager-based game;
the first interface board, comprising a second processor and a second memory, designed or configured to a) receive metering data from the master gaming controller via the first communication path, b) send metering data to a first remote server via a third communication path, c) send and receive player tracking information to the first remote server via the third communication path and d) control at least one peripheral device including communicating with the at least one peripheral device via a fourth communication path including an end point on the first interface board;
the second interface board, comprising a third processor and a third memory, designed or configured to a) receive, via a fifth communication path, data associated with the fourth communication path; b) interpret the data received via the fifth communication path; c) in response to interpreting the data, determine whether an event has occurred, d) generate a message including information related to the event and e) send the message to the master gaming controller via the second communication path; wherein in response to receiving the message an operation is effected on the gaming machine by the master gaming controller; and
an input device coupled to the master gaming controller for receiving cash or an indicia of credit.

2. The gaming machine of claim 1, wherein the first interface board and the at least one peripheral device are components of a player tracking unit coupled to the gaming machine.

3. The gaming machine of claim 1, wherein the at least one peripheral device is one of a card reader, a display or a mechanical key pad.

4. The gaming machine of claim 1, wherein the first interface board is further designed or configured to control a plurality of peripheral devices.

5. The gaming machine of claim 5, wherein the plurality of peripheral devices includes a card, a display and a mechanical key pad.

6. The gaming machine of claim 1, wherein the data received via the fifth communication path includes data associated with a player tracking system.

7. The gaming machine of claim 1, wherein the at least one peripheral device is a card reader and the data received via the fifth communication path includes card data read from a card inserted in the card reader.

8. The gaming machine of claim 1, wherein the display is a video display and wherein in response to receiving the message from the second interface board, the operation effected by the master gaming controller is to output video content on at least a portion of the video display.

9. The gaming machine of claim 8, wherein the video content is an enhancement to a player tracking function associated with the first interface board.

10. The gaming machine of claim 8, wherein the video content is generated from a media application downloaded from a second remote server communicatively coupled to the master gaming controller.

11. The gaming machine of claim 1, wherein the gaming machine further comprises the at least one peripheral device and wherein the second interface board is further designed or configured to send a command, instructions or data to the at least one peripheral device via the fifth communication path.

12. The gaming machine of claim 1, wherein the second interface board is further designed or configured to receive a first communication for the at least one peripheral device, to emulate the at least one peripheral device to generate a response to the first communication that the first interface board is programmed to receive from the at least one peripheral device and send the response to the first interface board via the fifth communication path.

13. The gaming machine of claim 12, wherein the at least one peripheral device is a card reader, a display or a mechanical key pad.

14. The gaming machine of claim 1, wherein the gaming machine further comprises the at least one peripheral device and wherein the second interface board is further designed or configured to control the at least one peripheral device.

15. The gaming machine of claim 1, wherein the second interface board is further designed or configured to communicate with a second remote server.

16. The gaming machine of claim 1, further comprising: a card reader coupled to the second interface board.

17. The gaming machine of claim 15, wherein the second interface board is further designed or configured to control the card reader and send information read from a card inserted into the card reader to the master gaming controller.

18. The gaming machine of claim 15, wherein the second interface board is further designed or configured to receive a first communication sent from the first communication board to the card reader and forward the first communication to the card reader.

19. The gaming machine of claim 1, wherein the at least one peripheral device that the first interface board is designed or configured to control is a first display device and wherein the second interface board is further designed or configured to i) receive a first communication sent from the first interface board to the first display device, said first communication including information to display on the first display device, ii) emulate the first display device to generate a response to the first communication that the first interface board is programmed to receive from the first display device and iii) generate a second communication that enables the information included in the first communication to be displayed on a second display device.

20. The gaming machine of claim 19, wherein the second display device is the display coupled to the master gaming controller.

21. The gaming machine of claim 1, wherein the at least one peripheral device that the first interface board is designed or configured to control is a mechanical key pad and wherein the second interface board is further designed or configured to i) receive data input via a touch screen display, ii) convert the data input via the touch screen display to a format that the first interface board is programmed to receive from the mechanical key pad and iii) send a first communication to the first interface board including the converted data.

22. The gaming machine of claim 1, wherein the second interface board is further designed or configured to receive information sent from the first interface board to the first remote server via the third communication path or sent from the first remote server to the first interface board via the third communication path.

23. The gaming machine of claim 1, wherein the second interface board is further designed or configured to emulate the player tracking host to generate a first communication to effect an first operation on the first interface board.

24. The gaming machine of claim 23, wherein the operation is related to a transfer of credits on the gaming machine.

25. The gaming machine of claim 23, wherein the operation is related to a bonus condition on the gaming machine.

26. A gaming machine comprising:
a master gaming controller, comprising a first processor and a first memory, designed or configured to control a wager-based game played on the gaming machine, communicatively coupled to a first interface board via a first communication path and a second interface board via a second communication path;
a display coupled to the master gaming controller designed or configured to output an outcome to the wager-based game;
the first interface board, comprising a second processor and a second memory, designed or configured to a) receive metering data from the master gaming controller via the first communication path, b) send metering data to a first remote server via a third communication path, c) send and receive player tracking information to the first remote server via the third communication path, d) control a card reader, a first display and a mechanical key pad; and e) communicate with the card reader, the first display and the mechanical key pad via one or more communication paths with end points on the first interface board;
the second interface board, comprising a third processor and a third memory, designed or configured to a) to receive communications from the first interface board to the card reader, the first display or the mechanical key pad sent via the one or more communication paths with the end points on the first interface board; b) interpret the communications; c) emulate the mechanical key pad and the first display to generate responses that the first interface board is programmed to receive from the mechanical key pad or the first display device; d) send the generated responses to the first interface board; and e) communication with the master gaming controller; and
an input device coupled to the master gaming controller for receiving cash or an indicia of credit.

27. The gaming machine of claim 26, wherein the master gaming controller is further designed or configured to receive information sent from the first interface board to the first display device via the one or more communication paths with endpoints on the first interface board from the second interface board via the second communication path and output the information on the display.
